(19) United States
(12) Patent Application Publication
(10) Pub. No.: US 2015/0092638 A1
(43) Pub. Date: Apr. 2, 2015

(54) DISCONTINUOUS TRANSMISSION TIMING FOR SYSTEMS WITH FLEXIBLE BANDWIDTH CARRIER

(71) Applicant: QUALCOMM Incorporated, San Diego, CA (US)

(72) Inventors: Ozgur Dural, San Diego, CA (US); Soumya Das, San Diego, CA (US); Edwin Chongwoo Park, San Diego, CA (US)

(73) Assignee: QUALCOMM Incorporated, San Diego, CA (US)

(21) Appl. No.: 14/038,871

(22) Filed: Sep. 27, 2013

(51) Int. Cl. H04W 76/04

(52) U.S. Cl. CPC H04W 76/048
USPC 370/311

(57) ABSTRACT

Methods, systems, and devices are provided for discontinuous transmission (DTX) in systems that utilize one or more flexible bandwidth carriers. Tools and techniques are provided that may help ensure signaling alignment, such as with respect to DTX cycles, in systems that may utilize one or more flexible bandwidth carriers. Such methods may include identifying at least a DTX cycle for a first cell or a DTX cycle for a second cell, wherein at least the first cell or the second cell utilizes at least one of the one or more flexible bandwidth carriers; and adjusting one or more DTX parameters for at least the first cell or the second cell to align the DTX cycle for the second cell with the DTX cycle for the first cell such that the DTX cycle for the second cell at least partially overlaps the DTX cycle for the first cell.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

Service providers are typically allocated blocks of frequency spectrum for exclusive use in certain geographic regions. These blocks of frequencies are generally assigned by regulators regardless of the multiple access technology being used. In most cases, these blocks are not integer multiples of channel bandwidths, hence there may be unutilized parts of the spectrum. As the use of wireless devices has increased, the demand for and value of this spectrum has generally surged, as well. Nonetheless, in some cases, wireless communications systems may not utilize portions of the allocated spectrum because the portions are not big enough to fit a standard or normal waveform. The developers of the LTE standard, for example, recognized the problem and decided to support many different system bandwidths (e.g., 1.4, 3, 5, 10, 15 and 20 MHz). This may provide one partial solution to the problem.

Flexible bandwidth systems, also referred to herein as scalable bandwidth systems, may provide for better utilization of bandwidth resources. However, some flexible bandwidth systems, such as systems that utilize discontinuous transmission (DTX) may face transmission alignment issues when they include multiple carriers that may utilize different bandwidths.

### SUMMARY

Methods, systems, and devices are provided for discontinuous transmission (DTX), such as that may improve timing relations, in systems that may utilize one or more normal bandwidth carriers and one or more flexible bandwidth carriers or in systems that may utilize multiple different flexible bandwidth carriers. For example, tools and techniques are provided that may help align a DTX cycle of a first cell with a DTX cycle of a second cell, particularly when the first and second cells utilize different bandwidth scaling factors. Aligning the respective DTX cycles for the first and second cells may include, for example, adjusting a DTX parameter of at least the first or second cell so that the DTX cycle for the second cell at least partially overlaps the DTX cycle for the first cell.

Flexible bandwidth carriers for wireless communications systems may utilize portions of spectrum that may not be big enough to fit a normal waveform utilizing flexible bandwidth waveforms. A flexible bandwidth system that utilizes a flexible bandwidth carrier may be generated with respect to a normal bandwidth system through dilating, or scaling down, the time or the chip rate of the flexible bandwidth system with respect to the normal bandwidth system. Some embodiments may increase the bandwidth of a waveform through expanding, or scaling up, the time or the chip rate of the flexible bandwidth system.

In systems that may utilize one or more flexible bandwidth carriers, misalignment of DTX cycles between multiple carriers may cause an increase in power consumed by the UE since it may be in the active state for any of the DTX cycle on duration and required system resources, such as increased processing time and consequently transmission delay, and a decrease in potential gain. An increase in processing time may be due to the fact that the DTX cycles are misaligned (e.g. the period or periodicity for N=2 or N=4 may be longer than for N=1) and consequently the system experiences delay. These problems may be addressed by aligning the DTX cycles for at least two carriers in a system, for example, by adjusting one or more DTX parameters in at least a first cell or a second cell.

Methods for DTX cycle alignment may be particularly useful in a High-Speed Uplink Packet Access (HSUPA) network that may utilize a primary serving Uplink High Speed-Dedicated Physical Control Channel (HS-DPCCH) cell with a normal chip rate, such as 3.84 Mcps (e.g., N=1) and a secondary serving HS-DPCCH cell(s) that may utilize a time dilated chip rate=3.84/2 Mcps (e.g., N=2) or 3.84/4 Mcps (e.g., N=4) or vice versa. Tools and techniques provided may support uplink DTX so that the DTX cycle utilized by a user equipment (UE) during UL DTX may be aligned between the primary serving HS-DPCCH cell (which may be N=1) and secondary serving HS-DPCCH cell(s) (which may utilize a flexible bandwidth carrier, such as with N=2 or N=4) or vice versa. Note that in some cases, a normal carrier may be considered a flexible bandwidth carrier with N=1.

Some embodiments include a method of discontinuous transmission (DTX) in a system that utilizes one or more flexible bandwidth carriers. The method may include: identifying at least a DTX cycle for a first cell or a DTX cycle for a second cell, where at least the first cell or the second cell utilizes at least one of the one or more flexible bandwidth carriers; and/or adjusting one or more DTX parameters for at least the first cell or the second cell to align the DTX cycle for the second cell with the DTX cycle for the first cell such that the DTX cycle for the second cell at least partially overlaps the DTX cycle for the first cell. In some cases, the system may include a multicarrier system. In some embodiments, adjusting the one or more DTX parameters to align the DTX cycle for the second cell with the DTX cycle for the first cell includes aligning a starting boundary of the DTX cycle for the second cell with a starting boundary of the DTX cycle for the first cell.

In some embodiments, the one or more DTX parameters include at least an enabling delay, a DTX cycle length, a DTX-DRX offset, an inactivity threshold, or a preamble length. In some embodiments, adjusting the one or more DTX parameters includes interpreting the one or more DTX parameters relative to a bandwidth scaling factor of the first cell. Adjusting the one or more DTX parameters may include interpreting the one or more DTX parameters relative to another bandwidth scaling factor, the another bandwidth scaling factor determined by comparing at least a bandwidth scaling factor of the first cell and a bandwidth scaling factor of the second cell. Adjusting the one or more DTX parameters may include interpreting the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

In some embodiments, the first cell includes a normal bandwidth carrier and the second cell includes one of the one or more flexible bandwidth carriers. For example, the first cell may include a bandwidth scaling factor equal to 1 and the second cell may include a bandwidth scaling factor equal to 2 or 4. In some embodiments, the first cell includes one of the one or more flexible bandwidth carriers and the second cell includes a normal bandwidth carrier. For example, the first cell may include a bandwidth scaling factor equal to 2 or 4 and the second cell may include a bandwidth scaling factor equal to 1. In some configurations, a scaling factor of the first cell is different from a scaling factor of the second cell. In some configurations, the first cell includes one of the one or more flexible bandwidth carriers and the second cell includes another one of the one or more flexible bandwidth carriers different from the first cell.

Some embodiments include system for discontinuous transmission (DTX) that utilizes one or more flexible bandwidth carriers. The system may include: means for identifying at least a DTX cycle for a first cell or a DTX cycle for a second cell, where at least the first cell or the second cell utilizes at least one of the one or more flexible bandwidth carriers; and/or means for adjusting one or more DTX parameters for at least the first cell or the second cell to align the DTX cycle for the second cell with the DTX cycle for the first cell such that the DTX cycle for the second cell at least partially overlaps the DTX cycle for the first cell. The system may include a multicarrier system.

The means for adjusting the one or more DTX parameters to align the DTX cycle for the second cell with the DTX cycle for the first cell may include means for aligning a starting boundary of the DTX cycle for the second cell with a starting boundary of the DTX cycle for the first cell. The one or more DTX parameters may include at least an enabling delay, a DTX cycle length, a DTX-DRX offset, an inactivity threshold, or a preamble length.

The means for adjusting the one or more DTX parameters may include means for interpreting the one or more DTX parameters relative to a bandwidth scaling factor of the first cell. The means for adjusting the one or more DTX parameters may include means for interpreting the one or more DTX parameters relative to another bandwidth scaling factor, the another bandwidth scaling factor determined by comparing at least a bandwidth scaling factor of the first cell and a bandwidth scaling factor of the second cell.

The means for adjusting the one or more DTX parameters may include means for interpreting the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

In some embodiments of the system, the first cell includes a normal bandwidth carrier and the second cell includes one of the one or more flexible bandwidth carriers. For example, the first cell may include a bandwidth scaling factor equal to 1 and the second cell may include a bandwidth scaling factor equal to 2 or 4. In some embodiments, the first cell includes one of the one or more flexible bandwidth carriers and the second cell includes a normal bandwidth carrier. For example, the first cell may include a bandwidth scaling factor equal to 2 or 4 and the second cell may include a bandwidth scaling factor equal to 1. In some configurations, a scaling factor of the first cell is different from a scaling factor of the second cell. In some configurations, the first cell includes one of the one or more flexible bandwidth carriers and the second cell includes another one of the one or more flexible bandwidth carriers different from the first cell.

Some embodiments include a computer program product for discontinuous transmission (DTX) in a system that utilizes one or more flexible bandwidth carriers that may include a non-transitory computer-readable medium that may include: code for identifying at least a DTX cycle for a first cell or a DTX cycle for a second cell, where at least the first cell or the second cell utilizes at least one of the one or more flexible bandwidth carriers; and/or code for adjusting one or more DTX parameters for at least the first cell or the second cell to align the DTX cycle for the second cell with the DTX cycle for the first cell such that the DTX cycle for the second cell at least partially overlaps the DTX cycle for the first cell. The system may include a multicarrier system.

The code for adjusting the one or more DTX parameters to align the DTX cycle for the second cell with the DTX cycle for the first cell may include code for aligning a starting boundary of the DTX cycle for the second cell with a starting boundary of the DTX cycle for The one or more DTX parameters may include at least an enabling delay, a DTX cycle length, a DTX-DRX offset, an inactivity threshold, or a preamble length.

The code for adjusting the one or more DTX parameters may include code for interpreting the one or more DTX parameters relative to a bandwidth scaling factor of the first cell. The code for adjusting the one or more DTX parameters may include code for interpreting the one or more DTX parameters relative to another bandwidth scaling factor, the another bandwidth scaling factor determined by comparing at least a bandwidth scaling factor of the first cell and a bandwidth scaling factor of the second cell. The code for adjusting the one or more DTX parameters may include code for interpreting the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

In some embodiments of the computer program product, the first cell includes a normal bandwidth carrier and the second cell includes one of the one or more flexible bandwidth carriers. For example, the first cell may include a bandwidth scaling factor equal to 1 and the second cell may include a bandwidth scaling factor equal to 2 or 4. In some embodiments, the first cell includes one of the one or more flexible bandwidth carriers and the second cell includes a normal bandwidth carrier. For example, the first cell may include a bandwidth scaling factor equal to 2 or 4 and the second cell may include a bandwidth scaling factor equal to 1. In some configurations, a scaling factor of the first cell is different from a scaling factor of the second cell. In some configurations, the first cell includes one of the one or more flexible bandwidth carriers and the second cell includes another one of the one or more flexible bandwidth carriers different from the first cell.

Some embodiments include a wireless communications device configured for discontinuous transmission (DTX) in a multicarrier system that utilizes one or more flexible bandwidth carriers. The device may include at least one processor that may be configured to: identify at least a DTX cycle for a first cell or a DTX cycle for a second cell, where at least the first cell or the second cell utilizes at least one of the one or more flexible bandwidth carriers; and/or adjust one or more DTX parameters for at least the first cell or the second cell to align the DTX cycle for the second cell with the DTX cycle for the first cell such that the DTX cycle for the second cell at least partially overlaps the DTX cycle for the first cell. The system may include a multicarrier system.

The at least one processor may be further configured to align a starting boundary of the DTX cycle for the second cell with a starting boundary of the DTX cycle for the first cell. The one or more DTX parameters may include at least an enabling delay, a DTX cycle length, a DTX-DRX offset, an inactivity threshold, or a preamble length.

The at least one processor may be further configured to interpret the one or more DTX parameters relative to a bandwidth scaling factor of the first cell. The at least one processor may be further configured to interpret the one or more DTX parameters relative to another bandwidth scaling factor, the another bandwidth scaling factor determined by comparing at least a bandwidth scaling factor of the first cell and a bandwidth scaling factor of the second cell. The at least one processor may be further configured to interpret the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

In some embodiments of the device, the first cell includes a normal bandwidth carrier and the second cell includes one of the one or more flexible bandwidth carriers. For example, the first cell may include a bandwidth scaling factor equal to 1 and the second cell may include a bandwidth scaling factor equal to 2 or 4. In some embodiments, the first cell includes one of the one or more flexible bandwidth carriers and the second cell includes a normal bandwidth carrier. For example, the first cell may include a bandwidth scaling factor equal to 2 or 4 and the second cell may include a bandwidth scaling factor equal to 1. In some configurations, a scaling factor of the first cell is different from a scaling factor of the second cell. In some configurations, the first cell includes one of the one or more flexible bandwidth carriers and the second cell includes another one of the one or more flexible bandwidth carriers different from the first cell.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. The same reference number, followed by different alphabetical descriptors across multiple figures may indicate different (or identical) versions of the same or similar element or component.

FIG. 1 shows a block diagram of a wireless communications system in accordance with various embodiments;

FIG. 2A shows an example of a wireless communications system where a flexible bandwidth waveform, also referred to as a scalable bandwidth waveform, fits into a portion of spectrum not broad enough to fit a normal waveform in accordance with various embodiments;

FIG. 2B shows an example of a wireless communications system where a flexible bandwidth waveform fits into a portion of spectrum near an edge of a band in accordance with various embodiments;

FIG. 3 shows a block diagram of a wireless communications system in accordance with various embodiments;

FIG. 4A shows a DTX timing diagram of two carriers having different bandwidth scaling factors in accordance with various embodiments;

FIG. 4B shows a DTX timing diagram of two carriers having different bandwidth scaling factors in accordance with various embodiments;

FIG. 4C shows a DTX timing diagram of two carriers having bandwidth different scaling factors in accordance with various embodiments;

FIG. 4D shows a DTX timing diagram of two carriers having different bandwidth scaling factors in accordance with various embodiments;

FIG. 5A shows a block diagram of a device configured for DTX in a system that utilizes flexible bandwidth carrier(s) in accordance with various embodiments;

FIG. 5B shows a block diagram of another device configured for DTX in a system that utilizes flexible bandwidth carrier(s) in accordance with various embodiments;

FIG. 6 shows a block diagram of a communications system configured in accordance with various embodiments;

FIG. 7 shows a block diagram of a user equipment configured in accordance with various embodiments;

FIG. 8 shows a block diagram of a wireless communications system that includes a base station and a user equipment in accordance with various embodiments;

FIG. 9A shows a flow diagram of a method of DTX in a system that utilizes flexible bandwidth carrier(s) in accordance with various embodiments;

FIG. 9B shows a flow diagram of a method of DTX in a system that utilizes flexible bandwidth carrier(s) in accordance with various embodiments; and

FIG. 9C shows a flow diagram of another method of DTX in a system that utilizes flexible bandwidth carrier(s) in accordance with various embodiments.

### DETAILED DESCRIPTION

Methods, systems, and devices are provided for discontinuous transmission (DTX), such as for improving timing relations, for systems that may utilize one or more flexible bandwidth carriers. For example, tools and techniques are provided that may help align a DTX cycle of a first cell with a DTX cycle of a second cell, particularly when the first and second cells utilize different bandwidth scaling factors. Aligning the respective DTX cycles for the first and second cells may include, for example, adjusting a DTX parameter of at least the first or second cell so that the DTX cycle for the second cell at least partially overlaps the DTX cycle for the first cell.

Flexible bandwidth carriers for wireless communications systems may utilize portions of spectrum that may not be big enough to fit a normal waveform utilizing flexible bandwidth waveforms. A flexible bandwidth system that utilizes a flexible bandwidth carrier may be generated with respect to a normal bandwidth system through dilating, or scaling down, the time or the chip rate of the flexible bandwidth system with respect to the normal bandwidth system. Some embodiments may increase the bandwidth of a waveform through expanding, or scaling up, the time or the chip rate of the flexible bandwidth system.

In systems that may utilize one or more flexible bandwidth carriers, misalignment of DTX cycles between multiple carriers may cause an increase in power consumed by the UE since it may be in the active state for any of the DTX cycle on duration and required system resources, such as increased processing time and consequently transmission delay, and a decrease in potential gain. An increase in processing time may be due to the fact that the DTX cycles are misaligned (e.g. the period or periodicity for N=2 or N=4 may be longer than for N=1) and consequently the system experiences delay. These problems may be addressed by aligning the DTX cycles for at least two carriers in a system, for example, by adjusting one or more DTX parameters in at least a first cell or a second cell.

Methods for DTX in a system that may utilize one or more flexible bandwidth cells may include identifying a DTX cycle for a first cell or a second cell, where at least the first cell or the second cell may utilize at least one or more flexible bandwidth carriers in a system. One or more DTX parameters for at least the first cell or the second cell may be adjusted to align the DTX cycles for the second cell with the DTX cycle for the first cell such that the DTX cycle for the second cell at least partially overlaps the DTX cycle for the first cell. In some cases, DTX alignment may result in system gains in the form of reduced delay time via more coordinated transmission, such as DTX, between cells.

Each DTX cycle may be defined by multiple DTX parameters, such as, for example, by a starting boundary of the DTX cycle. Methods for DTX may include adjusting the one or more DTX parameters to align the DTX cycle for the second cell with the DTX cycle for the first cell by aligning a starting boundary of the DTX cycle for the second cell with a starting boundary of the DTX cycle for the first cell.

Each DTX cycle may also be defined by, for example, an enabling delay, a DTX cycle length, a DTX to discontinuous reception (DRX) offset, an inactivity threshold, and/or a preamble index. Methods for DTX may include adjusting one or more of these DTX parameters so that the DTX cycles of two cells may be aligned, including so that the DTX cycles of the first and second cells may at least partially overlap each other in time.

Adjusting one or more DTX parameters may also include interpreting the one or more DTX parameters, as mentioned above, in terms of relative bandwidth, or a relative bandwidth scaling factor. For example, the bandwidth scaling factor of the first cell may be used as a reference for both the first and second cell DTX parameter(s). Other implementations may include interpreting one or more DTX parameters relative to another bandwidth scaling factor. The another bandwidth scaling factor may be determined by comparing at least a bandwidth scaling factor of the first cell and a bandwidth scaling factor of the second cell.

In some embodiments, adjusting one or more DTX parameters may also include interpreting the one or more DTX parameters relative to at least a highest bandwidth scaling factor or a lowest bandwidth scaling factor or a previously chosen scaling factor that may or may not be present in the current system. In some cases, the lowest and/or highest bandwidth scaling factor may be determined by comparing bandwidth scaling factors of at least the first and second cells by well know means in the art.

Methods for DTX cycle alignment may be particularly useful in a High-Speed Uplink Packet Access (HSUPA) network that may utilize a primary serving Uplink High Speed-Dedicated Physical Control Channel (HS-DPCCH) cell with a normal chip rate, such as 3.84 Mcps (e.g., N=1) and a secondary serving HS-DPCCH cell(s) that may utilize a time dilated chip rate=3.84/2 Mcps (e.g., N=2) or 3.84/4 Mcps (e.g., N=4) or vice versa. Tools and techniques provided may support uplink DTX so that the DTX cycle utilized by a user equipment (UE) during UL DTX may be aligned between the primary serving HS-DPCCH cell (which may be N=1) and secondary serving HS-DPCCH cell(s) (which may utilize a flexible bandwidth carrier, such as with N=2 or N=4) or vice versa.

In some implementations, the first cell may include a normal bandwidth carrier and the second cell may include one of the one or more flexible bandwidth carriers. In other implementations, the first cell may include a flexible bandwidth carrier and the second cell may include one of the one or more flexible bandwidth carriers different from the first cell. In some cases, the flexible bandwidth of the first cell may be greater than the flexible bandwidth of the second cell.

The methods of DTX as described herein can also be beneficially implemented when the first cell includes one or more flexible bandwidth carriers and the second cell includes a normal bandwidth carrier. In some cases, the first may cell include one or more flexible bandwidth carriers and the second cell may include one or more flexible bandwidth carriers different from the first cell. In some cases, the flexible bandwidth of the first cell may be less than the flexible bandwidth of the second cell. In some cases, a cell may indicate a single location or sector, and in other cases, a cell may indicate the utilization of certain carriers relative to a location or sector.

In yet other cases, the methods described herein can be implemented where the first cell may include a bandwidth scaling factor equal to 1 and the second cell may include a bandwidth scaling factor equal to 2 or 4. In some cases, the first cell may include a bandwidth scaling factor equal to 2 or 4 and the second cell may include a bandwidth scaling factor equal to 1.

Techniques described herein may be used for various wireless communications systems such as CDMA, TDMA, FDMA, OFDMA, SC-FDMA, Peer-to-Peer, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA or OFDM system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). Some systems may utilize high speed packet access (HSPA, HSPA+). 3GPP Long Term Evolution (LTE) and LTE-Advanced (LTE-A) are new releases of UMTS that use E-UTRA. UTRA, E-UTRA, UMTS, HSPA, HSPA+, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above, as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

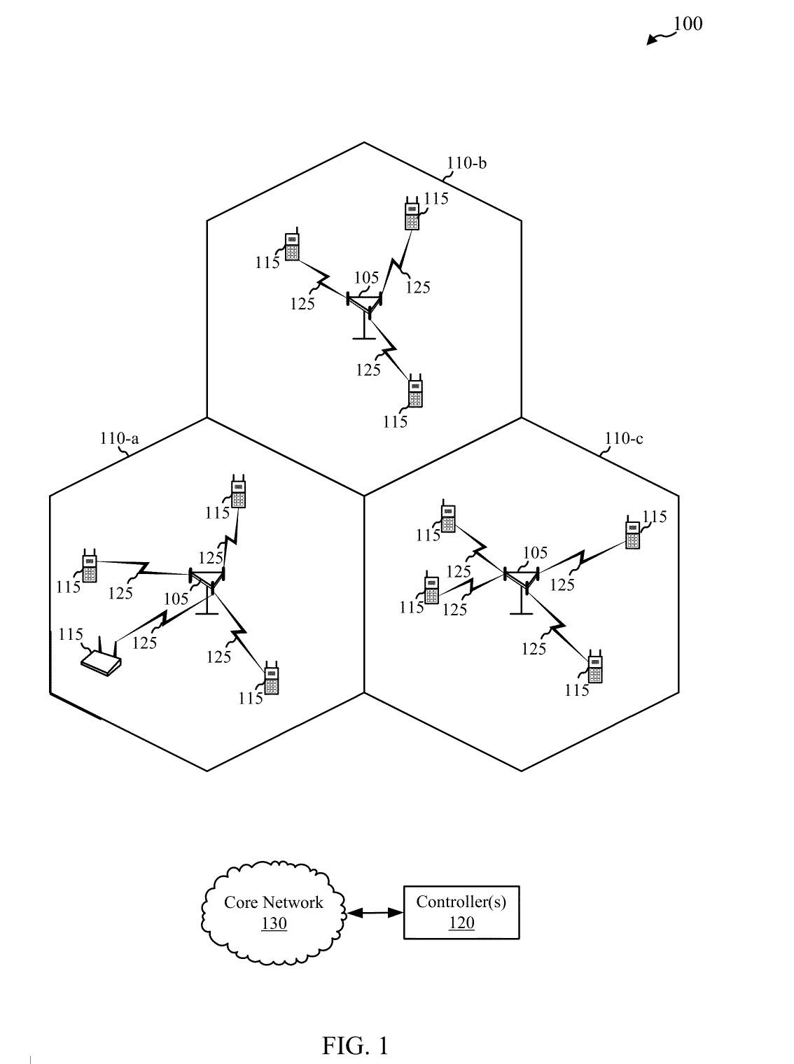

Referring first to FIG. 1, a block diagram illustrates an example of a wireless communications system 100 in accordance with various embodiments. The system 100 includes base stations 105, user equipment 115, a base station controller 120, and a core network 130 (the controller 120 may be integrated into the core network 130 in some embodiments; in some embodiments, controller 120 may be integrated into base stations 105). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The user equipment 115 may be any type of mobile station, user equipment, access terminal, subscriber unit, or user equipment. The user equipment 115 may include cellular phones and wireless communications devices, but may also include personal digital assistants (PDAs), smartphones, other handheld devices, netbooks, notebook computers, etc. Thus, the term user equipment should be interpreted broadly hereinafter, including the claims, to include any type of wireless or mobile communications device.

Throughout this application, some user equipment may be referred to as flexible bandwidth capable user equipment, flexible bandwidth compatible user equipment, and/or flexible bandwidth user equipment. This may generally mean that the user equipment is flexible capable or compatible. In general, these devices may also be capable of normal functionality with respect to one or more normal radio access technologies (RATs). The use of the term flexible as meaning flexible capable or flexible compatible may generally be applicable to other aspects of system 100, such as for controller 120 and/or base stations 105, or a radio access network.

The base stations 105 may wirelessly communicate with the user equipment 115 via a base station antenna. The base stations 105 may be configured to communicate with the user equipment 115 under the control of the controller 120 via multiple carriers. Each of the base station 105 sites can provide communication coverage for a respective geographic area. In some embodiments, base stations 105 may be referred to as a NodeB, eNodeB, Home NodeB, and/or Home eNodeB. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, micro, femto, and/or pico base stations).

The different aspects of system 100, such as the user equipment 115, the base stations 105, the core network 130, and/or the controller 120 may be configured to utilize flexible bandwidth and waveforms in accordance with various embodiments. System 100, for example, shows transmissions 125 between user equipment 115 and base stations 105. The transmissions 125 may include uplink and/or reverse link transmission, from a user equipment 115 to a base station 105, and/or downlink and/or forward link transmissions, from a base station 105 to a user equipment 115. The transmissions 125 may include flexible/scalable and/or normal waveforms. Normal waveforms may also be referred to as legacy and/or normal waveforms.

The different aspects of system 100, such as the user equipment 115, the base stations 105, the core network 130, and/or the controller 120 may be configured to utilize flexible bandwidth and waveforms in accordance with various embodiments. For example, different aspects of system 100 may utilize portions of spectrum that may not be big enough to fit a normal waveform. Devices such as the user equipment 115, the base stations 105, the core network 130, and/or the controller 120 may be configured to adapt the chip rates, spreading factor, and/or scaling factors to generate and/or utilize flexible bandwidth and/or waveforms. Some aspects of system 100 may form a flexible subsystem (such as certain user equipment 115 and/or base stations 105) that may be generated with respect to a normal subsystem (that may be implemented using other user equipment 115 and/or base stations 105) through dilating, or scaling down, the time of the flexible subsystem with respect to the time of the normal subsystem.

In some embodiments, different aspects of system 100, such as the user equipment 115, the base stations 105, the core network 130, and/or the controller 120 may be configured to identify at least a DTX cycle for a first cell or a DTX cycle for a second cell. Different aspects of system 100, such as the user equipment 115, the base stations 105, the core network 130, and/or the controller 120 may also be configured to adjust one or more DTX parameters for at least the first cell or the second cell to align the DTX cycle for the second cell with the DTX cycle for the first cell such that the DTX cycle for the second cell at least partially overlaps the DTX cycle for the first cell. At least the first cell or the second cell may include at least one or more flexible bandwidth carriers.

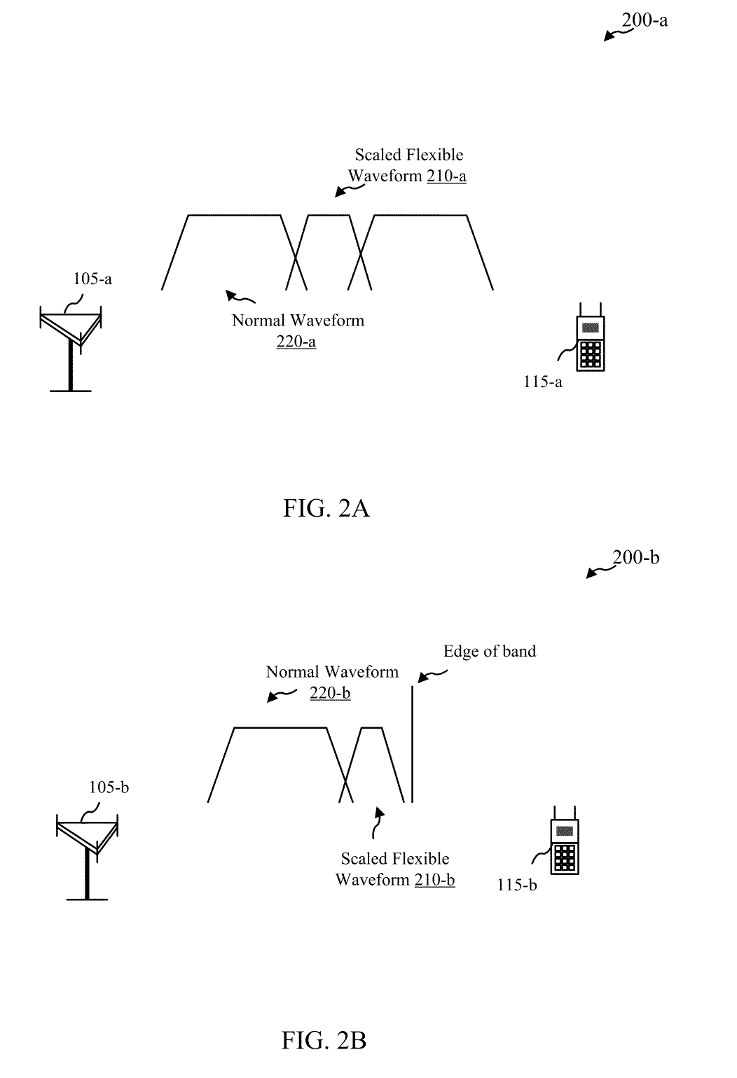

FIG. 2A shows an example of a wireless communications system 200-a with a base station 105-a and a user equipment 115-a in accordance with various embodiments, where a flexible bandwidth waveform 210-a fits into a portion of spectrum not broad enough to fit a normal waveform 220-a. System 200-a may be an example of system 100 of FIG. 1. In some embodiments, the flexible bandwidth waveform 210-a may overlap with the normal waveform 220-a that either the base 105-a and/or the user equipment 115-a may transmit. In some cases, the normal waveform 220-a may completely overlap the flexible bandwidth waveform 210-a. Some embodiments may also utilize multiple flexible bandwidth waveforms 210. In some embodiments, another base station and/or user equipment (not shown) may transmit the normal waveform 220-a and/or the flexible bandwidth waveform 210-a.

FIG. 2B shows an example of a wireless communications system 200-b with a base station 105-b and user equipment 115-b, where a flexible bandwidth waveform 210-b fits into a portion of spectrum near an edge of a band, which may be a guard band, where normal waveform 220-b may not fit. System 200-b may be an example of system 100 of FIG. 1. User equipment 115-a/115-b and/or base stations 105-a/105-b may be configured to dynamically adjust the bandwidth of the flexible bandwidth waveforms 210-a/210-b in accordance with various embodiments.

In some embodiments, different aspects of systems 200-a and/or 200-b, such as the user equipment 115-a and/or 115-b and/or the base stations 105-a and/or 105-b may be configured to identify at least a DTX cycle for a first cell or a DTX cycle for a second cell. Different aspects of systems 200-a and/or 200-b, such as the user equipment 115-a and/or 1150-b and/or the base stations 105-a and/or 105-b may be configured to adjust one or more DTX parameters for at least the first cell or the second cell to align the DTX cycle for the second cell with the DTX cycle for the first cell such that the DTX cycle for the second cell at least partially overlaps the DTX cycle for the first cell. At least the first cell or the second cell may include at least one or more flexible bandwidth carriers.

In general, a first waveform or carrier bandwidth and a second waveform or carrier bandwidth may partially overlap when they overlap by at least 1%, 2%, and/or 5%. In some embodiments, partial overlap may occur when the overlap is at least 10%. In some embodiments, the partial overlap may be less than 99%, 98%, and/or 95%. In some embodiments, the overlap may be less than 90%. In some cases, a flexible bandwidth waveform or carrier bandwidth may be contained completely within another waveform or carrier bandwidth. This overlap may still reflect partial overlap, as the two waveforms or carrier bandwidths do not completely coincide. In general, partial overlap can mean that the two or more waveforms or carrier bandwidths do not completely coincide (i.e., the carrier bandwidths are not the same).

Some embodiments may utilize different definitions of overlap based on power spectrum density (PSD). For example, one definition of overlap based on PSD is shown in the following overlap equation for a first carrier:

$$overlap = 100 \% * \frac{{\int }_{0}^{∞} {PSD}_{1} ( f ) * {PSD}_{2} ( f )}{{\int }_{0}^{∞} {PSD}_{1} ( f ) * {PSD}_{1} ( f )} .$$

In this equation, PSD₁(f) is the PSD for a first waveform or carrier bandwidth and PSD₂(f) is the PSD for a second waveform or carrier bandwidth. When the two waveforms or carrier bandwidths coincide, then the overlap equation may equal 100%. When the first waveform or carrier bandwidth and the second waveform or carrier bandwidth at least partially overlap, then the overlap equation may not equal 100%. For example, the Overlap Equation may result in a partial overlap of greater than or equal to 1%, 2%, 5%, and/or 10% in some embodiments. The overlap equation may result in a partial overlap of less than or equal to 99%, 98%, 95%, and/or 90% in some embodiments. One may note that in the case in which the first waveform or carrier bandwidth is a normal waveform or carrier bandwidth and the second waveform or a carrier waveform is a flexible bandwidth waveform or carrier bandwidth that is contained within the normal bandwidth or carrier bandwidth, then the overlap equation may represent the ratio of the flexible bandwidth compared to the normal bandwidth, written as a percentage. Furthermore, the overlap equation may depend on which carrier bandwidth's perspective the overlap equation is formulated with respect to. Some embodiments may utilize other definitions of overlap. In some cases, another overlap may be defined utilizing a square root operation such as the following:

$$overlap = 100 \% * \sqrt{\frac{{\int }_{0}^{∞} {PSD}_{1} ( f ) * {PSD}_{2} ( f )}{{\int }_{0}^{∞} {PSD}_{1} ( f ) * {PSD}_{1} ( f )}} .$$

Other embodiments may utilize other overlap equations that may account for multiple overlapping carriers.

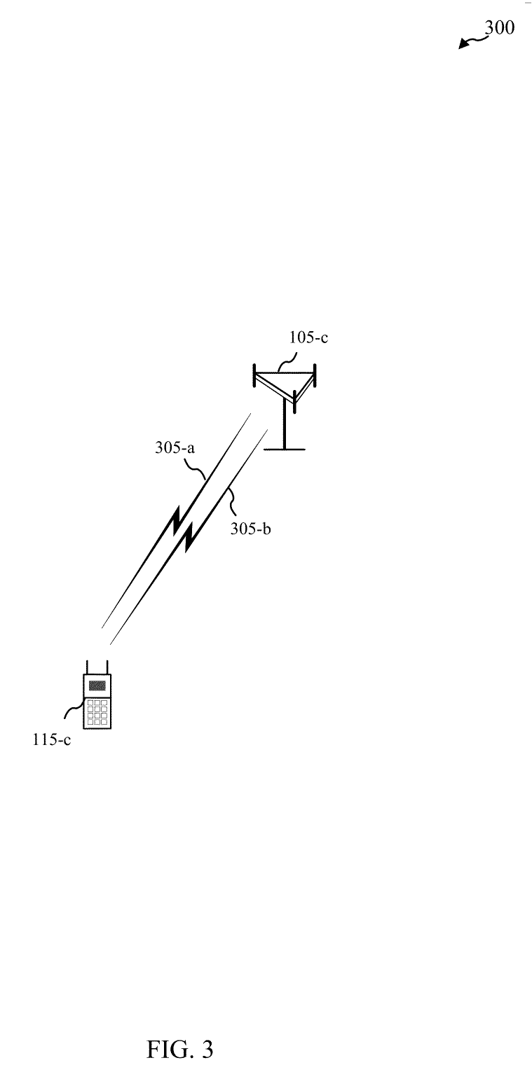

FIG. 3 shows a wireless communications system 300 with a base station 105-c and user equipment 115-c in accordance with various embodiments. Different aspects of system 300, such as the user equipment 115-c and/or the base stations 105-c, may be configured for DTX in system 300 that may utilize multiple carriers including one or more flexible bandwidth carriers.

Transmissions 305-a and/or 305-b between the user equipment 115-c and the base station 105-a may utilize normal and/or flexible bandwidth waveforms that may be generated to occupy less (or more) bandwidth than a normal waveform. For example, at a band edge, there may not be enough available spectrum to place a normal waveform. For a flexible bandwidth waveform, as time gets dilated, the frequency occupied by a waveform goes down, thus making it possible to fit a flexible bandwidth waveform into spectrum that may not be broad enough to fit a normal waveform. In some embodiments, the flexible bandwidth waveform may be scaled utilizing a scaling factor N with respect to a normal waveform. Scaling factor N may take on numerous different values including, but not limited to, integer values such as 1, 2, 3, 4, 8, etc. N, however, does not have to be an integer. In some cases, transmissions 305-a may be with respect to a primary serving cell and transmission 305-b may be with respect to a secondary serving cell. In other cases, transmissions 305-a and 305-b may between a single antenna of a user equipment 115-c and the same or different antennas of the base station 105-a.

Different aspects of system 300, such as the user equipment 115-c and/or the base stations 105-c, may be configured for identifying at least a DTX cycle for a first cell or a DTX cycle for a second cell. The user equipment 115-c and/or the base stations 105-c may adjust one or more DTX parameters for at least the first cell or the second cell to align the DTX cycle for the second cell with the DTX cycle for the first cell such that the DTX cycle for the second cell at least partially overlaps the DTX cycle for the first cell. In some cases, the one or more DTX parameters may include at least an enabling delay, a DTX cycle length, a DTX-DRX offset, an inactivity threshold, or a preamble length. At least the first cell or the second cell may include at least one or more flexible bandwidth carriers.

In some embodiments, the user equipment 115-c and/or the base stations 105-c, may be configured for aligning a starting boundary of the DTX cycle for the second cell with a starting boundary of the DTX cycle for the first cell, as part of adjusting the one or more DTX parameters to align the DTX cycle for the second cell with the DTX cycle for the first cell.

In some embodiments, the user equipment 115-c and/or the base stations 105-c may be configured to interpret the one or more DTX parameters relative to a bandwidth scaling factor of the first cell to further aid in adjusting the one or more DTX parameters for at least the first cell or the second cell to align the DTX cycle for the second cell with the DTX cycle for the first cell such that the DTX cycle for the second cell at least partially overlaps the DTX cycle for the first cell.

In some cases, the user equipment 115-c and/or the base stations 105-c may be configured to interpret the one or more DTX parameters relative to another bandwidth scaling factor to further aid in aligning the DTX cycles of the first and second cells. The another bandwidth scaling factor may be determined by comparing at least a bandwidth scaling factor of the first cell and a bandwidth scaling factor of the second cell. The another bandwidth scaling factor may include at least a highest bandwidth scaling factor or a lowest bandwidth scaling factor, which may be determined by comparing at least a bandwidth scaling factor of the first cell and a bandwidth scaling factor of the second cell.

In some embodiments, transmission 305-a may include one of the one or more flexible bandwidth carriers and transmission 305-b may include a normal bandwidth carrier. In some embodiments, transmission 305-a may include one of the one or more flexible bandwidth carriers and transmission 305-b may include one of the one or more flexible bandwidth carriers different from the first cell.

In some embodiments, transmission 305-a may include a bandwidth scaling factor equal to 1 and transmission 305-b may include a bandwidth scaling factor equal to 2 or 4. In other embodiments, transmission 305-a may include a bandwidth scaling factor equal to 2 or 4 and the transmission 305-b may include a bandwidth scaling factor equal to 1. In some embodiments, transmission 305-a may include a bandwidth scaling factor equal to 2 or 4 and transmission 305-b may include a bandwidth scaling factor equal to 2 or 4.

System 300 may be an example of a HSPA/HSPA+ network, such as a High-Speed Uplink Packet Access (HSUPA) network that may utilize a primary serving Uplink High Speed-Dedicated Physical Control Channel (HS-DPCCH) cell with a normal chip rate, such as 3.84 Mcps (e.g., N=1) and a secondary serving HS-DPCCH cell(s) that may utilize a time dilated chip rate=3.84/2 Mcps (e.g., N=2) or 3.84/4 Mcps (e.g., N=4) or vice versa. Tools and techniques provided may support uplink DTX so that the DTX cycle utilized by a user equipment (UE) during UL DTX may be aligned between the primary serving HS-DPCCH cell (which may be N=1) and secondary serving HS-DPCCH cell(s) (which may utilize a flexible bandwidth carrier, such as with N=2 or N=4) or vice versa.

Some embodiments may utilize additional terminology. A new unit D may be utilized. The unit D is dilated. The unit is unitless and has the value of N. One can talk about time in the flexible system in terms of “dilated time”. For example, a slot of say 10 ms in normal time may be represented as 10 Dms in flexible time (note: even in normal time, this will hold true since N=1 in normal time: D has a value of 1, so 10 Dms=10 ms). In time scaling, one can replace most “seconds” with “dilated-seconds”. Note frequency in Hertz is 1/s.

As discussed above, a flexible bandwidth or scalable bandwidth waveform may be a waveform that occupies less bandwidth than a normal waveform. Thus, in a flexible bandwidth system, the same number of symbols and bits may be transmitted over a longer duration compared to normal bandwidth system. This may result in time stretching, whereby slot duration, frame duration, etc., may increase by a scaling factor N. Scaling factor N may represent the ratio of the normal bandwidth to flexible bandwidth (BW). Thus, data rate in a flexible bandwidth system may equal (Normal Rate×1/N), and delay may equal (Normal Delay×N). In general, a flexible systems channel BW=channel BW of normal systems/N. Delay×BW may remain unchanged. Furthermore, in some embodiments, a flexible bandwidth waveform may be a waveform that occupies more bandwidth than a normal waveform. Scaling factor N may also be referred to as a bandwidth scaling factor.

Throughout this specification, the term normal system, subsystem, and/or waveform may be utilized to refer to systems, subsystems, and/or waveforms that involve embodiments that may utilize a scaling factor that may be equal to one (e.g., N=1) or a normal or standard chip rate. These normal systems, subsystems, and/or waveforms may also be referred to as standard and/or legacy systems, subsystems, and/or waveforms. Furthermore, flexible systems, subsystems, and/or waveforms may be utilized to refer to systems, subsystems, and/or waveforms that involve embodiments that may utilize a scaling factor that may be not equal to one (e.g., N=2, 4, 8, ½, ¼, etc.). For N>1, or if a chip rate is decreased, the bandwidth of a waveform may decrease. Some embodiments may utilize scaling factors or chip rates that increase the bandwidth. For example, if N<1, or if the chip rate is increased, then a waveform may be expanded to cover bandwidth larger than a normal waveform. Some embodiments may utilize a chip rate divisor (Dcr) to change the chip rate in some embodiments. Flexible systems, subsystems, and/or waveforms may also be referred to as scalable systems, subsystems, and/or waveforms in some cases. Flexible systems, subsystems, and/or waveforms may also be referred to as fractional systems, subsystems, and/or waveforms in some cases. Fractional systems, subsystems, and/or waveforms may or may not change bandwidth, for example. A fractional system, subsystem, or waveform may be flexible because it may offer more possibilities than a normal or standard system, subsystem, or waveform (e.g., N=1 system). Furthermore, the use of the term flexible may also be utilized to mean flexible bandwidth capable.

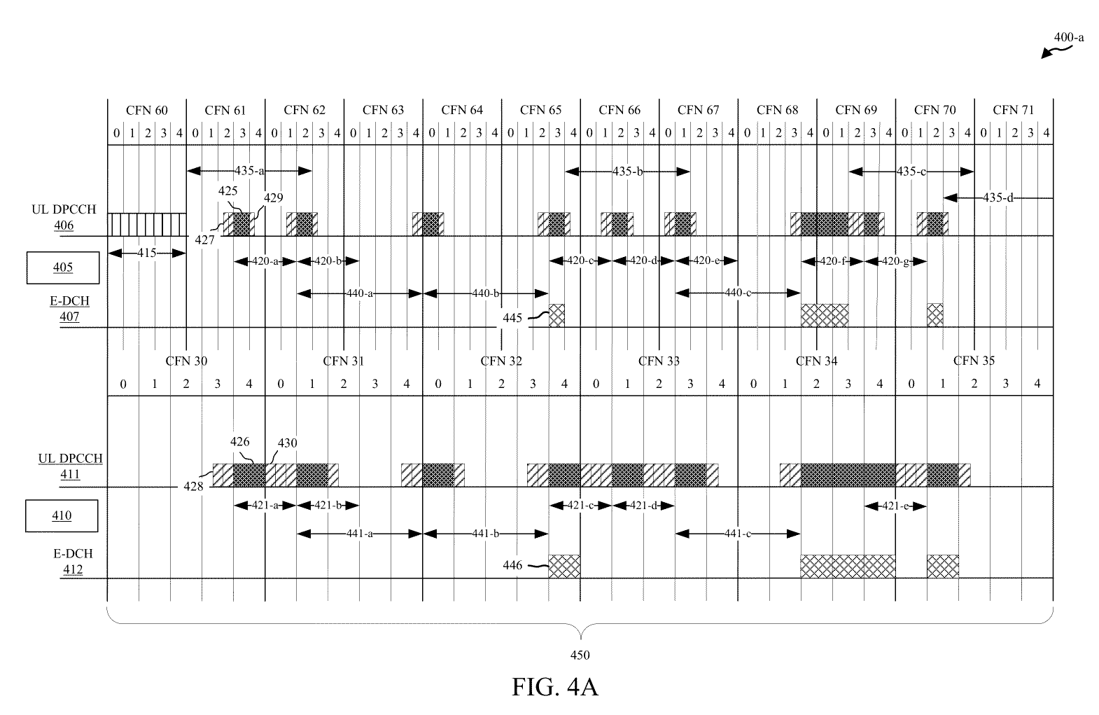

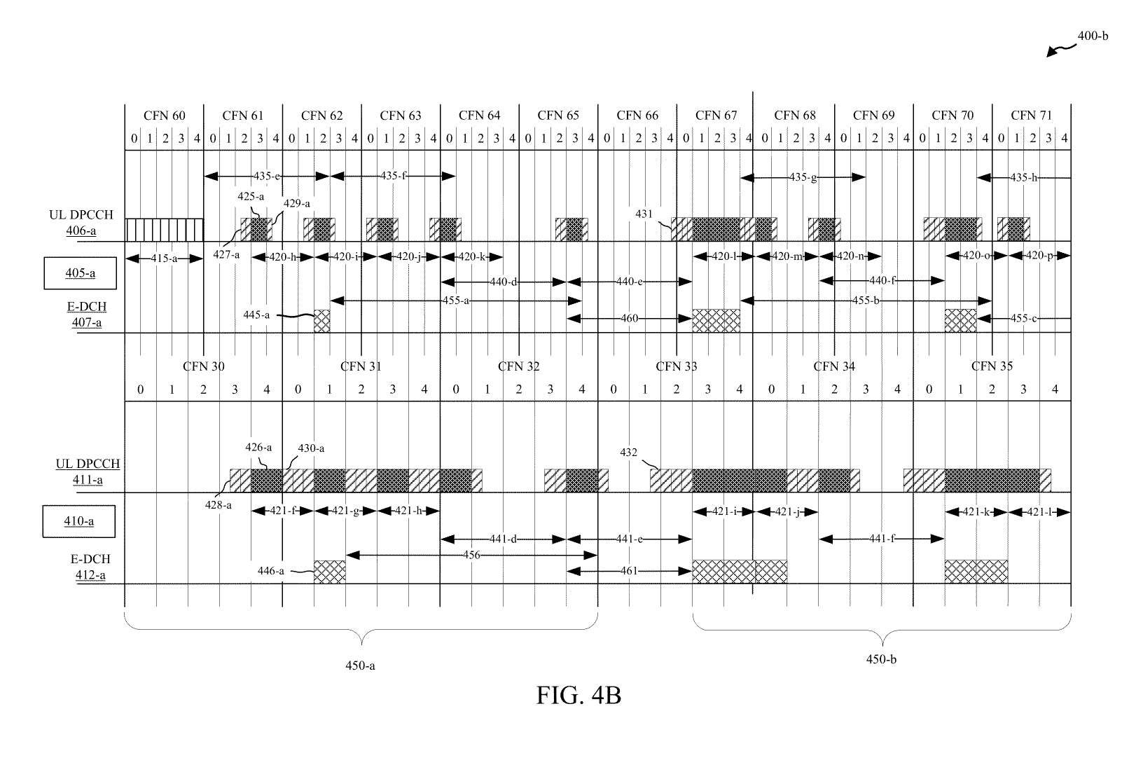

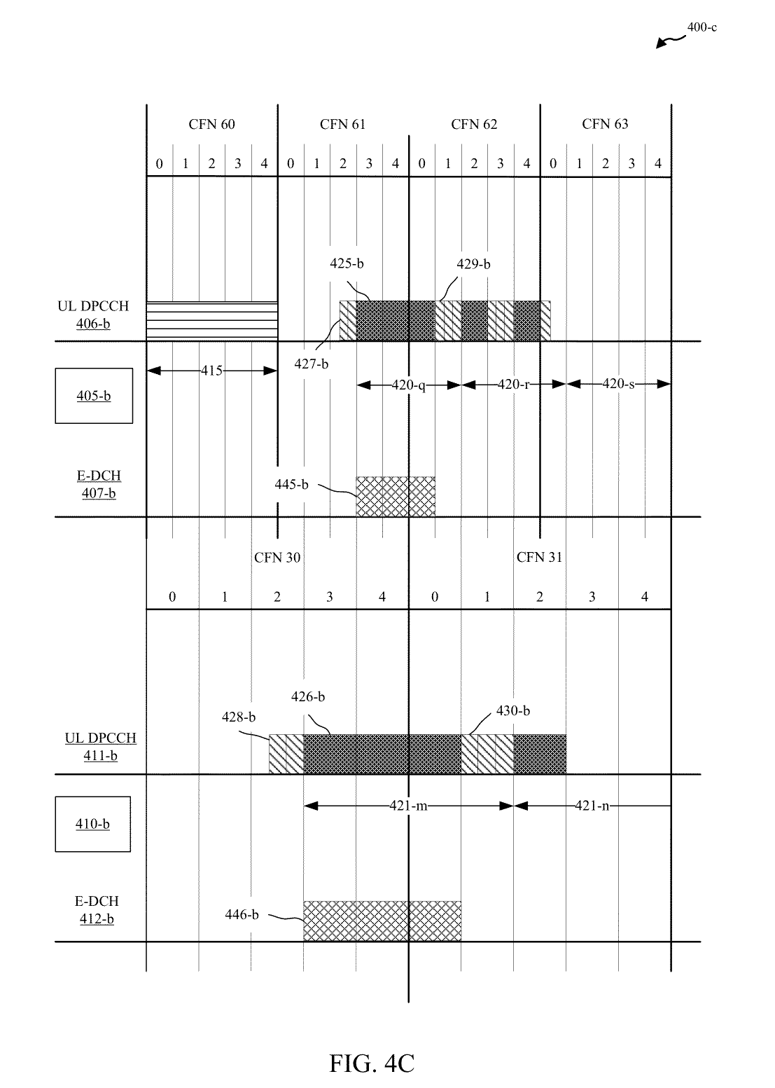

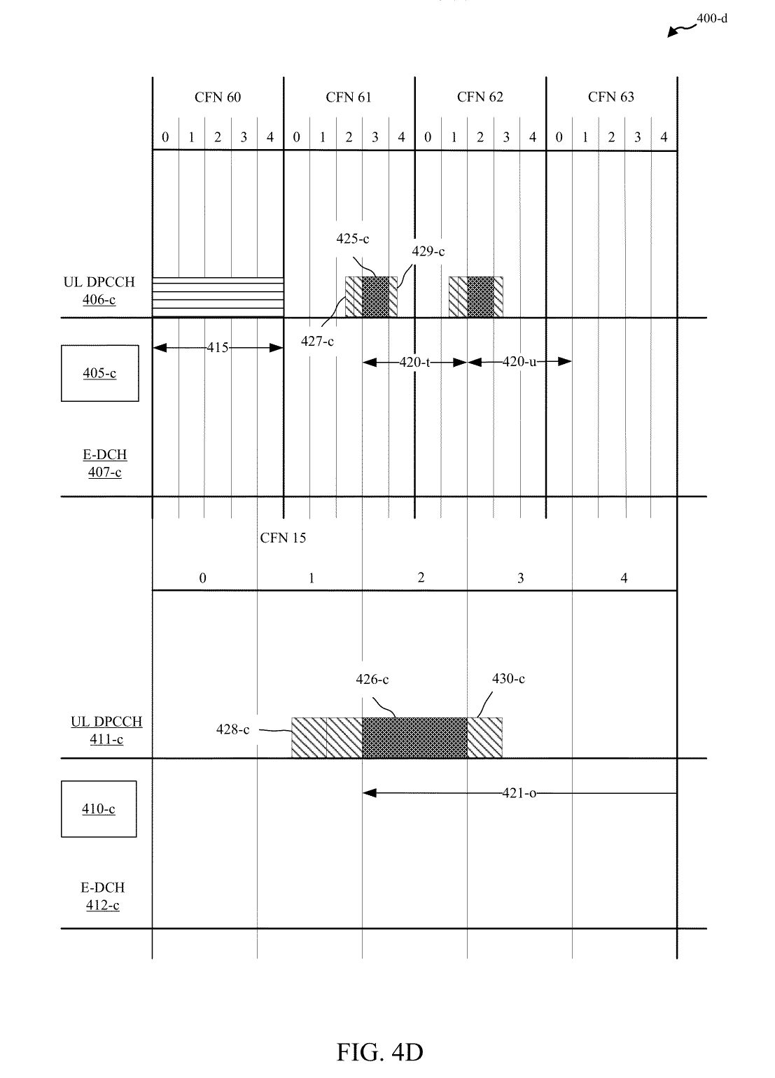

Turning next to FIGS. 4A-4D, DTX timing diagrams illustrate multiple configurations 400, including configurations 400-a, 400-b, 400-c, and 400-d that each include DTX functionality in a system that utilizes one or more flexible bandwidth carriers in accordance with various embodiments. The DTX timing diagrams may be examples of DTX methods, such as DTX signaling alignment, implemented or configured by various wireless entities, including all or part of: the base stations 105 of FIG. 1, FIG. 2A, FIG. 2B, and FIG. 3; the user equipment 115 of FIG. 1, FIG. 2A, FIG. 2B, FIG. 3; and/or the controller 120/core network 130 of FIG. 1. The common aspects between FIGS. 4A-4D will be described generally, and the particulars of each FIG. will then be described separately.

In some embodiments, configurations 400 of FIGS. 4A-4D may be implemented in a wireless communication system utilizing High-Speed Uplink Packet Access (HSUPA). A primary serving cell 405, such as an Uplink High Speed-Dedicated Physical Control Channel (HS-DPCCH) cell, may have a scaling factor of N=1. A secondary serving cell 410, which may also be a HS-DPCCH cell, may have a scaling factor of N=2 or N=4. Conversely, in some embodiments, the primary serving cell 405 may have a scaling factor of N=2 or N=4, and the secondary serving cell 410 may have a scaling factor of N=1.

In some embodiments, the primary serving cell 405 may include multiple channels, such as an Uplink Dedicated Control Channel (UL DPCCH) 406 and/or an Enhanced Dedicated Channel (E-DCH) 407. After an activation or enabling delay 415, which may be of a length of 1 frame (5 subframes) and which may be enabled via RRC signaling, a UE 115, for example in a next frame, may transmit an UL DPCCH DTX burst (also referred to herein as DTX burst) 425 during one or more DTX cycles, such as UE_DTX_cycle_{—}1 420. Each UE_DTX_cycle_{—}1 420 may be 4 subframes in length, or any other suitable length. In some cases, each UE_DTX_cycle_{—}1 420 may be 8 subframes in length. In some cases, the UE 115 may transmit during two different DTX cycles, such as UE_DTX_cycle_{—}1 420, which may be 4 subframes in length, and during a UE_DTX_cycle_{—}2 440, which may be 8 subframes in length. UE_DTX_cycle_{—}1 420 and UE_DTX_cycle_{—}2 440 may overlap and/or start in the same subframe at certain times.

In some embodiments, the secondary serving cell 410 may include multiple channels, such as an Uplink Dedicated Control Channel (UL DPCCH) 411 and/or an Enhanced Dedicated Channel (E-DCH) 412. The UE 115 may transmit an UL DPCCH DTX burst (also referred to herein as DTX burst) 426 during one or more DTX cycles, such as UE_DTX_cycle_{—}1 421. Each UE_DTX_cycle_{—}1 421 may be 4 subframes in length, or any other suitable length. In some cases, each UE_DTX_cycle_{—}1 421 may be 8 subframes in length. In some cases, the UE 115 may transmit during two different DTX cycles, such as UE_DTX_cycle_{—}1 421, which may be 4 subframes in length, and during a UE_DTX_cycle_{—}2 441, which may be 8 subframes in length. UE_DTX_cycle_{—}1 421 and UE_DTX_cycle_{—}2 441 may overlap and/or start in the same subframe at certain times.

In some cases, each DTX burst 425, 426 may be preceded by a DTX preamble 427, 428 which may include 2 blocks each ⅓ subframes in length, such that a DTX preamble 427, 428 may be ⅔ subframes in length. However, in some cases, the length of the DTX preamble 427, 428 may vary. The DTX preamble 427, 428 may contain control information, information/instructions related to the DTX burst 425, 426, etc. A DTX burst 425, 426 may be followed by a postamble 429, 430 which may be ⅓ subframes in length or ½ the length of a DTX preamble 427, 428. In some cases, however, the length of one or more DTX postamble 429, 430 may vary. In some cases, one or more preambles 427, 428 may abut, overlap, or be distinct from one or more postambles 429, 430.

In some embodiments, an inactivity threshold for the UE_DTX_cycle_{—}2 (also referred to as an inactivity threshold herein) 435 may indicate when the UE 115 is to move from UE_DTX_cycle_{—}1 420 to UE_DTX_cycle_{—}2 440 (only shown for primary serving cell 405, but the same applies for secondary cell 410). In some cases the inactivity threshold 435 may start at the end of the enabling delay 415, last for 8 subframes, and end in the middle of UE_DTX_cycle_{—}1 420, which may correspond to one subframe after a UE_DTX_cycle_{—}2 440 begins. In some configurations, the UE 115 transmits via DTX, such as a DTX burst 425, at the beginning of a UE_DTX_cycle_{—}1 420 or UE_DTX_cycle_{—}2 440. Thus, when the UE 115 is operating in UE_DTX_cycle_{—}2 440, the UE 115 may transmit DTX bursts 425 less frequently than if it was operating in UE_DTX_cycle_{—}1 420. In some cases this ratio may be equal to 2 DTX bursts 425 during UE_DTX_cycle_{—}1 420 (e.g. at the beginning of 2 successive UE_DTX_cycle_{—}1 420 periods) to every 1 DTX burst 425 during the UE_DTX_cycle_{—}2 440.

Coordinated transmission of one or more E-DCH bursts 445 may also take place over the E-DCH 407 in relation to transmission over UL DPCCH 406, such as one or more DTX bursts 425. In some cases, the one or more E-DCH bursts 445 may also include an E-DPCCH or an E-DPDCH burst. The transmission of an E-DCH burst 445 may align with the transmission of one or more DTX bursts 425. In some cases, the transmission of an E-DCH burst 445 may indicate or correspond to the UE 115 switching from one DTX cycle to another, such as from UE_DTX_cycle_{—}2 440 to UE_DTX_cycle_{—}1 420, or vice versa. An E-DCH burst 445 may be transmitted solitarily, or in continuous blocks, such as 3 E-DCH bursts 445 transmitted back to back. In some cases, when 3 E-DCH bursts 445 are transmitted continuously, 3 corresponding DTX bursts 425 may also be transmitted continuously, without one or more preambles 427 or postambles 429 in between each DTX burst 425 in the block of 3 DTX bursts 425. In some cases, the inactivity threshold 435 may restart after the complete transmission of an E-DCH burst 445.

Coordinated transmission of one or more E-DCH bursts 446 may also take place over the E-DCH 412 in relation to transmission over UL DPCCH 411, such as one or more DTX bursts 426. In some cases, the one or more E-DCH bursts 446 may also include an E-DPCCH or an E-DPDCH burst. The transmission of an E-DCH burst 446 may align with the transmission of one or more DTX bursts 426. In some cases, the transmission of an E-DCH burst 446 may indicate or correspond to the UE 115 switching from one DTX cycle to another, such as from UE_DTX_cycle_{—}2 441 to UE_DTX_cycle_{—}1 421, or vice versa. An E-DCH burst 446 may be transmitted solitarily, or in continuous blocks, such as 3 E-DCH bursts 446 transmitted back to back. In some cases, when 3 E-DCH bursts 446 are transmitted continuously, 3 corresponding DTX bursts 426 may also be transmitted continuously, without one or more preambles 428 or postambles 430 in between each DTX burst 426 in the block of 3 DTX bursts 426. In some cases, an inactivity threshold (not shown) may restart after the complete transmission of an E-DCH burst 446. In some embodiments, only one inactivity timer 435 may be utilized for both the primary serving cell 405 and the secondary serving cell 410.

In some cases, such as when a UE 115 transmits multiple DTX bursts 425, 426 over multiple cells 405, 410 having different bandwidth scaling factors, misalignment of the DTX bursts 425, 426 may occur, thus causing inefficiencies in the operation of the UE 115. These inefficiencies may include unwanted and excessive power consumption by the UE 115 when the DTX bursts 425, 426 cross one or more cells do not align with a discontinuous reception (DRX) cycle of a base station 105, controller 120, core network 130, etc. By aligning the DTX cycles, such as UE_DTX_cycle_{—}1 420 over the UL DPCCH 406 with UE_DTX_cycle_{—}1 421 (also referred to herein as a floor UE_DTX_cycle_{—}1 421) over the UL DPCCH 411, and hence aligning one or more DTX bursts 425 and 426, so that they at least partially overlap, the misalignment problems with respect to the different flexible bandwidth cells may be minimized. Misalignment problems between DTX cycles of cells having different flexible bandwidths may also be addressed by aligning the UE_DTX_cycle_{—}2 440 over the UL DPCCH 406 with UE_DTX_cycle_{—}2 441 over the UL DPCCH 411, and hence aligning one or more DTX bursts 425 and 426. In some cases, these alignment techniques may also include aligning E-DCH bursts 445 and 446 across E-DCH 407 and E-DCH 412.

In some embodiments, the CFN's of one or cells 405, 410 may increment by 1, 2, or 4, or any other value. In some cases, the CFN's may be relative to an N=1 cell, such that each CFN for a normal bandwidth carrier increments by one. For a N=2 carrier, in order to align with an N=1 carrier, each CFN on the N=2 carrier may increment by two. For a N=4 carrier, in order to align with an N=1 carrier, each CFN on the N=4 carrier may increment by four. In other cases, the CFN's may be relative to an N=2 cell, such that each CFN increments by two, or relative to a N=4 cell, such that each CNF increments by 4. In other embodiments, CFN's for an N=1 cell, or a n N=2 or 4 cell, may only utilize even or odd numbers.

In some cases, a CFN for a carrier, such as the normal carrier 405, may not completely align or be numbered the same as another carrier, such as flexible bandwidth carrier 410, or vice versa. However, for ease of understanding, FIGS. 4A-4D show CFN's for multiple carriers as aligned. It should be appreciated that the claimed subject matter is not so limited.

As described above, the primary serving cell 405 may have multiple UE_DTX_cycle_{—}1 420, each of a length of 4 subframes. The secondary serving cell 410 may have multiple UE_DTX_cycle_{—}1 421. Each UE_DTX_cycle_{—}1 420, 421 can be represented by the following:

((5*CFN_DRX_{N}−UE_DTX_DRX_Offset_{N}+S_{N})MOD UE_{—}DTX_cycle_{—}1_{N})=0 (1)

And each UE_DTX_cycle_{—}2 440, 441 may be represented by the following:

((5*CFN_DRX_{N}−UE_DTX_DRX_Offset_{N}+S_{N})MOD UE_DTX_cycle_{—}2_{N})=0 (2)

Both Equations (1) and (2) may be further related to the following:

CFN_DRX_{N}=Floor((CFN_DRX_{N=1})/N); (3)

UE_DTX_DRX_Offset_{N}=Floor((UE_DTX_DRX_Offset_{N=1})/N) (4)

where for N=4,UE_DTX_DRX_Offset_{N=1}>5; (5)

UE_DTX_cycle_{—}1_{N}=Floor((UE_DTX_cycle_{—}1_{N=1})/N); (6)

and

UE_DTX_cycle_{—}2_{N}=Floor((UE_DTX_cycle_{—}2_{N=1})/N) (7)

The inactivity thresholds 435 for two or more different flexible bandwidth carriers may be represented by the following:

(Inactivity Threshold for UE_DTX_cycle_{—}2)_{N}=(Inactivity Threshold for UE_DTX_cycle_{—}2)_{N=1}/N (8)

In some cases, the relationship between the Media Access Control (MAC) layer over the multiple different flexible bandwidth carriers may be represented by:

MAC_DTX_cycle_{N}=MAC_DTX_cycle_{N=1}/N (9)

and

(MAC Inactivity Threshold)_{N}=(MAC Inactivity Threshold)_{N=1}/N (10)

Various examples of DTX alignment techniques in relation to the above equations will be described in more detail below in reference to FIGS. 4A-4D.

Now with reference to FIG. 4A, configuration 400-a is shown with a primary serving cell 405 (N=1), and a secondary serving cell 410 (N=2). The primary serving cell 405 is shown with multiple UE_DTX_cycle_{—}1 420-a through 420-g, each of a length of 4 subframes, during which one or more DTX bursts 425 are transmitted across the UL DPCCH 406. The secondary serving cell 410 is shown with multiple UE_DTX_cycle_{—}1 421-a through 421-e, during which one or more DTX bursts 426 are transmitted across the UL DPCCH 411. UE_DTX_cycle_{—}1 421-a through 421-e are shown each scaled by a factor of 2 to be 2 subframes in length each according to Equations (1) and (6). As secondary serving cell 410 is an N=2 cell, UE_DTX_cycle_{—}1 421-a through 421-e normally may be 4 subframes in length. However, by dividing the length of each UE_DTX_cycle_{—}1 421-a through 421-e by 2, one or more DTX bursts 426 across UL DPCCH 411 may be aligned with one or more DTX bursts 425 across UL DPCCH 406.

In some cases, each DTX burst 425 across UL DPCCH 406 (having N=1) may have 2 preamble blocks 427 and 1 postamble block 429, with each block being of the same length, for example ⅓ subframes. Each DTX burst 426 across UL DPCCH 411 (having N=2) may have also have 2 preamble blocks 428 and 1 postamble block 430, with each block being of the same length, for example ⅓ subframes. However, because UL DPCCH 411 is a flexible bandwidth carrier having N=2, the preamble 428 and postamble 430 of each DTX burst 426 may be twice as long in time as each preamble 427 and postamble 429 of each DTX burst 425 across the UL DPCCH 406. In some cases, DTX alignment may be realized either alone or in combination with other techniques described herein, by aligning one or more of the preamble length 427 with preamble length 428 and/or postamble length 429 with postamble length 430 of DTX bursts 425 and 426. This may further help to align one or more DTX bursts 425 over the primary serving cell 405 with one or more DTX bursts 426 over the secondary serving cell 410, which may be a flexible bandwidth carrier.

In some cases, each cell 405 and 410 may have multiple UE_DTX_cycle_{—}2 440-a through 440-c and 441-a through 441-c. UE_DTX_cycle_{—}2 440-a through 440-c each may be 8 subframes in length. Corresponding UE_DTX_cycles_{—}2's 441-a through 441-c of the secondary serving cell 410, per a normal configuration, may be 8 subframes in length. However, to better align UE DTX bursts 425 and 426, the lengths of each UE_DTX_cycle_{—}2 441-a through 441-c may be divided by 2, for example, to correspond to the undilated length of UE_DTX_cycle_{—}2 440-a through 440-c across the primary serving cell 405 according to Equations (2) and (7). This may result in better DTX alignment for a UE 115 using multiple different flexible bandwidth carriers and may further result in better power efficiency for the UE 115.

In some cases, it may be beneficial to align a starting boundary of one or more UE DTX cycles, such as UE_DTX_cycle_{—}1 420-a though 420-d and 420-f and/or UE_DTX_cycle_{—}2 440-a through 440-c, across one cell, such as primary serving cell 405, with a starting boundary of a one or more UE DTX cycles, such as UE_DTX_cycle_{—}1 421-a though 421-e and/or UE_DTX_cycle_{—}2 441-a through 441-c, across another cell, such as secondary serving cell 410. In some cases, it may be useful to align an ending boundary of UE DTX cycles across multiple different carriers (not shown) where at least one of those carriers is a flexible bandwidth carrier. In yet other cases, it may be useful to align a center point of UE DTX cycles across multiple different carriers (not shown) to address DTX alignment problems. In some cases, by aligning a starting boundary (or ending boundary or center point) of UE DTX cycles across multiple different carriers where at least one of those carriers is a flexible bandwidth carrier, in combination with scaling the UE DTX cycles across one carrier relative to a bandwidth scaling factor of one of the carriers, such as a primary serving cell 405 (e.g., N=1), alignment of one or more DTX bursts 425 and 426 may be realized.

In some cases, multiple inactivity thresholds for UE_DTX_cycle_{—}2 435-a through 435-d may be implemented across the UL DPCCH 406. Upon the expiration of a timer associated with the inactivity threshold 435-a through 435-d, the UE 115 may move from UE DXT cycle 1 420 to UE_DTX_cycle_{—}2 440. For example, inactivity threshold 435-a may begin in the subframe immediately following an enabling delay 415 and be 8 subframes in length. Upon the expiration of the inactivity threshold 435-a, which may correspond to a second subframe of UE_DTX_cycle_{—}1 420-b, the UE 115 may switch from UE_DTX_cycle_{—}1 420-b to UE_DTX_cycle_{—}2 440-a. In some cases, UE_DTX_cycle_{—}2 440-a may begin in the same subframe as UE_DTX_cycle_{—}1 420-b, which may correspond to 1 subframe before the ending of inactivity threshold 435-a. In some embodiments, an inactivity timer associated with an inactivity threshold, for example inactivity threshold 435-d, may restart after transmission of an E-DCH burst 445.

In some embodiments, during a time 450, the UE 115 may transmit E-DCH bursts 445 and 446 at any time over the E-DCH 407, 412. In some cases, an E-DCH burst 445 across the E-DCH 407 may be transmitted at a same time as a DTX burst 425 across the UL DPCCH 406, such as beginning after UE_DTX_cycle_{—}2 440-b ends and at the start of UE_DTX_cycle_{—}1 420-c. In some cases, after transmission of the E-DCH burst 445, the UE 115 may switch back to UE_DTX_cycle_{—}1, such as UE_DTX_cycle_{—}1 420-c, and inactivity threshold 435-b may begin.

In some cases, by aligning one or more parameters of one or more DTX cycles across multiple carriers, such as cells 405 and 410, having different bandwidth scaling factors, better DTX alignment may be realized. In some cases, this may include adjusting and/or scaling one or more inactivity thresholds for UE_DTX_cycle_{—}2 across one cell, such as one or more inactivity thresholds across cell 410 having N=2 (not shown) to align with one or more inactivity thresholds 435-a through 435-d across primary cell 405 having N=1. In some cases this may be done according to Equation (8) above and may include dividing one or more inactivity thresholds for carrier 410 by N=2 to match one or more inactivity thresholds 435-a through 435-d for carrier 405. In some cases, this may be done either separately or in combination with alignment techniques mentioned above, such as adjusting preamble and postamble lengths across multiple carriers having different bandwidth scaling factors to allow for back to back transmission of DTX bursts. In some cases, E-DCH bursts 445 and 446 may be aligned to better facilitate DTX alignment across cell 405 (N=1) and cell 410 (N=2).

In some embodiments, multiple E-DCH bursts 445 may be transmitted back to back over the E-DCH 411, such as 3 E-DCH bursts, each 1 subframe in length, transmitted during UE_DTX_cycle_{—}1 420-f. In some cases, 3 DTX bursts 425 may be transmitted during UE_DTX_cycle_{—}1 420-f such that each DTX burst 425 aligns with an E-DCH burst 445. This may be accomplished by modifying the preamble 427 of a first DTX burst 425 transmitted at the beginning of UE_DTX_cycle_{—}1 420-f to include information relevant to the subsequent 2 DTX bursts 425 such that 3 DTX bursts 425 may be transmitted back to back without the need for separate preambles 427. Furthermore, in some cases, a similar modification may be done to the postamble 429 of 2 DTX bursts 425 transmitted at the beginning of the UE_DTX_cycle_{—}1 420-f such that only one postamble 429 is needed for 3 DTX bursts 425 sent during UE_DTX_cycle_{—}1 420-f, where the postamble 429 is transmitted at the beginning of a next UE_DTX_cycle_{—}1 420-g.

In some embodiments, each UE DTX cycle, such as UE_DTX_cycle_{—}1 420, 421, and UE_DTX_cycle_{—}2 440, 441, may correspond to a discontinuous reception (DRX) cycle of one or more base stations 105, controller(s) 120, and/or core network(s) 130. In some embodiments, to allow time for processing of DTX signaling, discrepancies in transmission times of DX signaling, to improve single reception, etc., a UE_DTX_DRX_offset for one or more cells may be implemented. In some cases, a length of one or more DRX periods/cycles and a length of one or more UE_DTX_DRX_offsets may be relative to a bandwidth scaling factor of the serving cell. For example, because secondary serving cell 410 (N=2) is dilated by a factor of 2 with respect to primary serving cell 405 (N=1), although being the same subframe length, a DRX period for the primary serving cell 405 may be half as long in time as a DRX period for the secondary serving cell 410, as represented by Equation (3) above. Furthermore, a UE_DTX_DRX_offset for the primary serving cell 405 may be half as long in time as a UE_DTX_DRX_offset for the secondary serving cell 410, as represented by Equation (4) above. In some cases, DTX alignment may be realized by dividing a UE_DTX_DRX_offset for the secondary serving cell 410 by 2 in order to be the same length in time as a UE_DTX_DRX_offset for the primary serving cell 405. In some cases this may allow for more coordination, particularly with respect to DTX and DRX operations, between multiple cells having different bandwidth scaling factors. In some embodiments, where one cell may have an N=4, a UE_DTX_DRX_offset should be greater than 5, according to Equation (5), to avoid inherent misalignment due to each frame being 5 subframes in length.

Now with reference to FIG. 4B, configuration 400-b is shown with a primary serving cell 405-a (N=1), and a secondary serving cell 410-a (N=2). The primary serving cell 405-a is shown with multiple UE_DTX_cycle_{—}1 420-h through 420-p, each of a length of 4 subframes, during which one or more DTX bursts 425-a are transmitted across the UL DPCCH 406-a. The secondary serving cell 410-a is shown with multiple UE_DTX_cycle_{—}1 421-f through 421-l, during which one or more DTX bursts 426-a are transmitted across the UL DPCCH 411-a. UE_DTX_cycle_{—}1 421-f through 421-l are shown each scaled by a factor of 2 to be 2 subframes in length each, according to Equations (1) and (6). As secondary serving cell 410-a is an N=2 cell, UE_DTX_cycle_{—}1 421-f through 421-l normally may be 4 subframes in length. However, by dividing the length of each UE_DTX_cycle_{—}1 421-f through 421-l by 2, one or more DTX bursts 426-a across UL DPCCH 411-a may be aligned with one or more DTX bursts 425-a across UL DPCCH 406-a.

As shown in FIG. 4B, a starting boundary of UE_DTX_cycle_{—}1 420-h through 420-j, 420-l, 420-m, 420-o, and 420-p of the primary serving cell 405-a (N=1) may be aligned with a starting boundary of UE_DTX_cycle_{—}1 421-f through 421-h, and 421-i through 420-l of the secondary serving cell 410-a; however, other alignments are intended to be within the scope of the claimed subject matter. Other alignments may include aligning an ending boundary, a center point, or another reference point of one or more UE_DTX_cycle_{—}1 420 with UE_DTX_cycle_{—}1 421 and/or one or more UE_DTX_cycle_{—}2 440 with UE_DTX_cycle_{—}2 441. In some embodiments, alignment may include aligning DTX bursts 425-a and 426-a without necessarily aligning the corresponding UE DTX cycles of the primary serving cell 405-a and the secondary serving cell 410-a.

In some cases, each cell 405-a and 410-a may have multiple UE_DTX_cycle_{—}2 440-d through 440-f and 441-d through 441-f. UE_DTX_cycle_{—}2 440-d through 440-f each may be 8 subframes in length. Corresponding UE_DTX_cycle_{—}2 441-d through 441-f of the secondary serving cell 410-a, per a normal configuration, would be 8 subframes in length. However, to better align UE DTX bursts 425-a and 426-a, the lengths of each UE_DTX_cycle_{—}2 441-d through 441-f may be divided by 2, for example, to correspond to the undilated length in time of UE_DTX_cycle_{—}2 440-d through 440-f across the primary serving cell 405-a, according to Equations (2) and (7). In some cases, the alignment of UE_DTX_cycle_{—}1 across the primary serving cell 405-a and the secondary serving cell 410-a may be done in conjunction with the alignment of UE_DTX_cycle_{—}2 across the primary serving cell 405-a and the secondary serving cell 410-a for better alignment. This may result in better DTX alignment for a UE 115 using multiple different flexible bandwidth carriers and may further result in better power efficiency for the UE 115.

In some cases, it may be beneficial to align a starting boundary of one or more UE DTX cycles, such as UE_DTX_cycle_{—}2 440-d through 440-f across the primary serving cell 405-a, with a starting boundary of a one or more UE DTX cycles, such as UE_DTX_cycle_{—}2 441-d through 441-f across the secondary serving cell 410-a. In some cases, it may be useful to align an ending boundary of UE DTX cycles across multiple different carriers (not shown) where at least one of those carriers is a flexible bandwidth carrier. In yet other cases, it may be useful to align a center point of UE DTX cycles across multiple different carriers (not shown) to address DTX alignment problems. In some cases, by aligning a starting boundary (or ending boundary or center point) of UE DTX cycles across multiple different carriers where at least one of those carriers is a flexible bandwidth carrier, in combination with scaling the UE DTX cycles across one carrier relative to a bandwidth scaling factor of one of the carriers, such as a primary serving cell 405-a (N=1), alignment of one or more UE DTX cycles and hence DTX bursts 425-a and 426-a may be realized.

In some cases, each DTX burst 425-a across UL DPCCH 406-a (having N=1) may have 2 preamble blocks 427-a and 1 postamble block 429-a, with each block being of the same length, for example ⅓ subframes. Each DTX burst 426-a across UL DPCCH 411-a (having N=2) may have also have 2 preamble blocks 428-a and 1 postamble block 430-a, with each block being of the same length, for example ⅓ subframes. However, because UL DPCCH 411-a is a flexible bandwidth carrier having N=2, the preamble 428-a and postamble 430-a of each DTX burst 426-a may be twice as long in time as each preamble 427-a and postamble 429-a of each DTX burst 425-a across the UL DPCCH 406-a. Furthermore, DTX bursts 425-a and 426-a may be configured to have a long preamble 431, 432, 4 blocks in length, each block being ⅓ subframes. In some embodiments, the long preamble 431, 432 may be associated with a UE_DTX_cycle_{—}2, such as UE_DTX_cycle_{—}2 440-e and 441-e. In some cases, DTX alignment may be realized either alone or in combination with other techniques described herein, by aligning or adjusting the length of one or more of preamble length 427-a with preamble length 428-a, long preamble length 431 with long preamble length 432, and/or postamble length 429-a with postamble length 430 of DTX bursts 425-a and 426-a. This may further help to align one or more DTX bursts 425-a over the primary serving cell 405-a with one or more DTX bursts 426-a over the secondary serving cell 410-a, which may be a flexible bandwidth carrier.

In some cases, multiple inactivity thresholds for UE_DTX_cycle_{—}2 435-e through 435-h may be implemented across the UL DPCCH 406-a. Upon the expiration of a timer associated with the inactivity threshold 435-e through 435-h, the UE 115 may move from UE DXT cycle 1 420 to UE_DTX_cycle_{—}2 440. For example, inactivity threshold 435-f may begin a subframe after UE_DTX_cycle_{—}1 420-i begins and may be 8 subframes in length. Upon the expiration of the inactivity threshold 435-f, which may correspond to a second subframe of UE_DTX_cycle_{—}1 420-k, the UE 115 may switch from UE_DTX_cycle_{—}1 420-k to UE_DTX_cycle_{—}2 440-d. In some cases, UE_DTX_cycle_{—}2 440-d may begin in the same subframe as UE_DTX_cycle_{—}1 420-k, which may correspond to 1 subframe before the ending of inactivity threshold 435-f.

In some embodiments, during times 450-a and 450-b, the UE 115 may transmit E-DCH bursts 445-a and 446-a at any time over the E-DCH 407-a and E-DCH 412-a. In some cases, an E-DCH burst 445-a across the E-DCH 407-a may be transmitted at a same time as a DTX burst 425-a across the UL DPCCH 406-a, such as beginning after UE_DTX_cycle_{—}2 440-e ends and at the start of UE DTX cycle 420-l. In some cases, after transmission of the E-DCH burst 445-a, the UE 115 may switch back to UE_DTX_cycle_{—}1, such as UE_DTX_cycle_{—}1 420-l, and inactivity threshold 435-g may begin in the third subframe of UE_DTX_cycle_{—}1 420-l.

In some cases, by aligning one or more parameters of one or more DTX cycles across multiple carriers, such as 405-a and 410-a, having different bandwidth scaling factors, better DTX alignment may be realized. In some cases, this may include adjusting and/or scaling one or more inactivity thresholds for UE_DTX_cycle_{—}2 across one cell, such as one or more inactivity thresholds across secondary serving cell 410-a having N=2 (not shown) to align with one or more inactivity thresholds 435-e through 435-h across primary cell 405-a having N=1. In some cases this may be done according to Equation (8) above and may include dividing one or more inactivity thresholds for secondary serving cell 410-a by 2 to match one or more inactivity thresholds 435-e through 435-h for primary serving cell 405-a. In some cases, this may be done either separately or in combination with alignment techniques mentioned above, such as adjusting preamble and postamble lengths across multiple carriers having different bandwidth scaling factors to allow for back to back transmission of DTX bursts. In some cases, E-DCH bursts 445-a and 446-a may be aligned to better facilitate DTX alignment across primary serving cell 405-a and secondary serving cell 410-a.

In some embodiments, one or more Media Access Control (MAC) DTX cycles 460, 461 may further be implemented across the primary serving cell 405-a and the secondary serving cell 410-a, with a corresponding DTX burst 425-a and 426-a being transmitted across UL DPCCH 406-a and 411-a at the beginning of each of the MAC DTX cycles 460, 461. MAC_DTX_cycle 460 across the primary serving cell 405-a may be 8 subframes in length and MAC_DTX_cycle 461 across the secondary serving cell 410-a may normally be 8 subframes in length. However, because secondary serving cell 410-a is dilated by a factor of 2 with respect to primary serving cell 405-a, MAC_DTX_cycle 461 may be twice as long in time as MAC_DTX_cycle 460. In some cases, to better align the MAC_DTX_cycles 460 and 461, according to Equation (9), the length of MAC_DTX_cycle 461 may be divided by 2 to better align with MAC_DTX_cycle 460.

In some embodiments, the MAC layer may further be defined by a MAC inactivity threshold 455, 456, such as MAC inactivity threshold 455-a through 455-c over the primary serving cell 405-a, and MAC inactivity threshold 456 over the secondary serving cell 410-a, each of 16 subframes in length. In some cases, MAC inactivity threshold 455-a may begin after an E-DCH burst 445-a is transmitted during a UE_DTX_cycle_{—}1 420-i, which may also correspond to the same subframe that inactivity threshold 435-f begins. MAC inactivity threshold 455-b may begin in the same subframe as inactivity threshold 435-g, also after an E-DCH burst 445-a is transmitted during a UE_DTX_cycle_{—}1 420-m.

In some cases, upon the expiration of a MAC inactivity timer associated with MAC inactivity threshold 455-a, the UE 115 MAC layer may then perform E-TFC selection based on the MAC_DTX_cycle 460. Mac inactivity threshold 455-a may end immediately after the transmission of a DTX burst 425-a, where the MAC_DTX_cycle 460 may begin upon the transmission of the same DTX burst 425-a. In some cases, an E-DCH burst 445-a, 446-a may be transmitted over the E-DCH 407-a, 412-a after the end of a MAC_DTX_cycle, such a MAC_DTX_cycle 460, 461. A MAC inactivity timer associate with MAC inactivity threshold 455-c, may restart after an E-DCH transmission, such as an E-DCH burst 445-a, 446-a.

In some cases, because the secondary serving cell 410-a is dilated by a factor of 2 relative to the primary serving cell 405-a, MAC inactivity threshold 456 may be twice as long in time as MAC inactivity threshold 455-a, 455-b, 455-c. In some cases, better DTX alignment may be realized by scaling the MAC inactivity threshold 456 down by a factor of 2 according to Equation (10). This may further help align MAC inactivity threshold 455-a with MAC inactivity threshold 456, for example.

In some cases, DTX alignment may include aligning an enabling delay 415-a of the primary serving cell 405-a with an enabling delay (not shown) of the secondary serving cell 410-a. Because secondary serving cell 410-a is an N=2 cell, an enabling delay may be twice as long in time as an enabling delay 415-a across a normal bandwidth cell 405-a having N=1, each being 5 subframes in length. This may cause misalignment between DTX bursts 425-a and 426-a over the primary serving cell 405-a and the secondary serving cell 410-a having different bandwidth scaling factors. For example, DTX burst 425-a during UE_DTX_cycle_{—}1 420-h begins only 3 subframes after the enabling delay 415-a over the primary serving cell 405-a. Because the secondary serving cell 410-a is dilated by a factor of 2 with respect to the primary serving cell 405-a, if the secondary serving cell 410-a were to utilize a dilated (unadjusted) enabling delay, alignment of UE_DTX_cycle_{—}1 420-h over the primary serving cell 405-a with the UE_DTX_cycle_{—}1 421-f over the secondary serving cell 410-a would not be possible. However, by dividing the length of the enabling delay across secondary serving cell 410-a by 2 to match the enabling delay 415-a, UE_DTX_cycle_{—}1 420-h and 421-f may be aligned, thus resulting in the respective DTX bursts 425-a and 426-a transmitted at the start of those UE DTX cycles being aligned as well.

Now with reference to FIG. 4C, configuration 400-c is shown with a primary serving cell 405-b (N=1), and a secondary serving cell 410-b (N=2). The primary serving cell 405-b is shown with multiple UE_DTX_cycle_{—}1 420-q through 420-s, each of a length of 4 subframes, during which one or more DTX bursts 425-b are transmitted across the UL DPCCH 406-b. The secondary serving cell 410-b is shown with multiple UE_DTX_cycle_{—}1 421-m and 421-n, each with a dilated (unadjusted) length of 4 subframes, during which one or more DTX bursts 426-b are transmitted across the UL DPCCH 411-b. Each DTX burst 425-b may have a preamble 427-b and a postamble 429-b, and each DTX burst 426-b may have a preamble 428-b and a postamble 430-b, as described above in reference to FIGS. 4A and 4B.

In the embodiment shown, the center point of UE_DTX_cycle_{—}1 421-m is aligned with a center point of UE_DTX_cycle_{—}1 420-q. In some cases this may result in at least partial overlap of DTX bursts 425-b over primary serving cell 405-b and DTX bursts 426-b over secondary serving cell 426-b. 3 back to back E-DCH bursts 445-b may be transmitted across the E-DCH 407-b that correspond to 3 back to back DTX bursts 425-b transmitted over the UL DPCCH 406-b during UE_DTX_cycle_{—}1 420-q. In this implementation, 3 back to back E-DCH bursts 446-b may be transmitted across the E-DCH 412-b that correspond to 3 back to back DTX bursts 426-b transmitted over the UL DPCCH 411-b during UE_DTX_cycle_{—}1 421-m. Because the UE_DTX_cycle_{—}1 421-m and 421-n (and UE_DTX_cycle_{—}2 440 not shown) are twice as long in time than the corresponding UE_DTX_cycle_{—}1 420-q, 420-r, and 420-s, the DTX bursts 426-b and the E-DCH bursts 446-b transmitted over the secondary serving cell 410-b may not completely align with the DTX bursts 425-b and the E-DCH bursts 445-b transmitted over the primary serving cell 405-b. In some cases, by aligning the centers of UE_DTX_cycle_{—}1 420-q and UE_DTX_cycle_{—}1 421-m, 2 out of 3 DTX bursts 425-b and 426-b may be aligned. In some cases, it may not be possible to align the center points of multiple consecutive UE DTX cycles 421-m and 421-n over the secondary serving cell 410-b with UE_DTX_cycle_{—}1 420-q and 420-r due to the dilated (unadjusted) lengths of UE_DTX_cycle_{—}1 421-m and 421-n. As a result, in some embodiments, a UE DTX cycle 420-q may be center point aligned with a UE_DTX_cycle_{—}1 421-m, while consecutive UE_DTX_cycle_{—}1 421-r may not be center point aligned with consecutive UE_DTX_cycle_{—}1 421-n. In some cases, such as when a DTX burst 425-b is transmitted in the middle of a UE_DTX_cycle_{—}1, such as UE_DTX_cycle_{—}1 420-r, DTX alignment may still be realized with a DTX burst 426-b transmitted in the beginning of UE_DTX_cycle_{—}1 421-n, even though center point alignment is not possible for consecutive UE_DTX_cycle_{—}1 421-n.

In some cases, a similar (or different) alignments may also be used for UE_DTX_cycle_{—}2 across primary serving cell 405-b and secondary serving cell 410-b.

FIG. 4C is only intended as an example of another alignment between UE DTX cycles of multiple cells having different bandwidth carriers; the claimed subject matter is not so limited. Other alignments, such as end boundary alignment of UE DTX cycles for example, may also be implemented with varying DTX burst transmission patterns between multiple cells.

Now with reference to FIG. 4D, configuration 400-d is shown with a primary serving cell 405-c (N=1), and a secondary serving cell 410-c (N=4). The primary serving cell 405-c is shown with multiple UE_DTX_cycle_{—}1 420-t and 420-u, each of a length of 4 subframes, during which one or more DTX bursts 425-c may be transmitted across the UL DPCCH 406-c. The secondary serving cell 410-c is shown with UE_DTX_cycle_{—}1 421-o with a dilated (unadjusted) length of 4 subframes, during which a DTX bursts 426-b may be transmitted across the UL DPCCH 411-c. Each DTX burst 425-c may have a preamble 427-c and a postamble 429-c, and DTX burst 426-c may have a preamble 428-c and a postamble 430-c, as described above in reference to FIGS. 4A and 4B. As secondary serving cell 410-c is dilated by a factor of 4 with respect to primary serving cell 405-c, UE_DTX_cycle_{—}1 421-o (and UE_DTX_cycle_{—}2 441 not shown), DTX burst 426-c, preamble 428-c, and postamble 430-c may be 4 times as long in time than the corresponding UE_DTX_cycle_{—}1 420-t (and UE_DTX_cycle_{—}2 440 not shown), DTX burst 425-c, preamble 427-c, and postamble 429-c of the primary serving cell 405-c.

In some cases, DTX alignment may be implemented by aligning a starting boundary of UE_DTX_cycle_{—}1 421-o over the secondary serving cell 410-c with UE_DTX_cycle_{—}1 420-t over the primary serving cell 405-c. In some embodiments, UE_DTX_cycle_{—}1 421-o may be left dilated (i.e. 4 times as long in time as UE DTX cycle 405-c), for ease of implementation, to account for limited data rates across a flexible bandwidth cell, etc. One or more other alignment techniques described above in reference to FIGS. 4A-4C may also be utilized in combination with configuration 400-d.

The above descriptions of various DTX alignments techniques are only intended as examples, where one or more of the above techniques may be combined with one another and/or modified to better suit a particular implementation, etc.

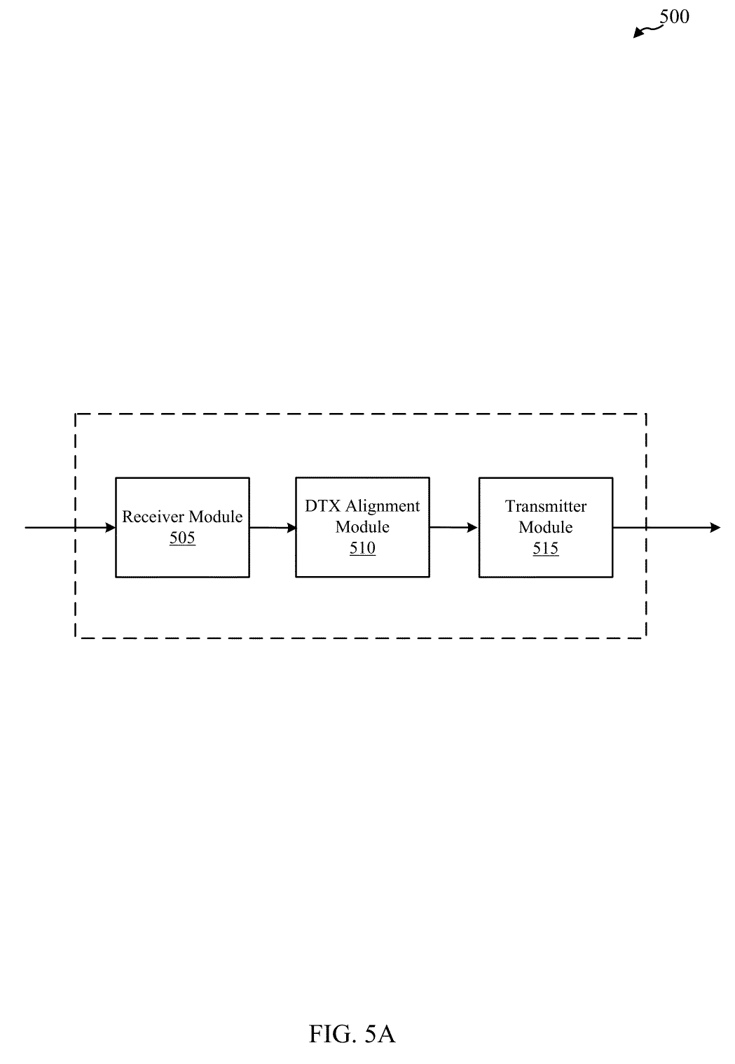

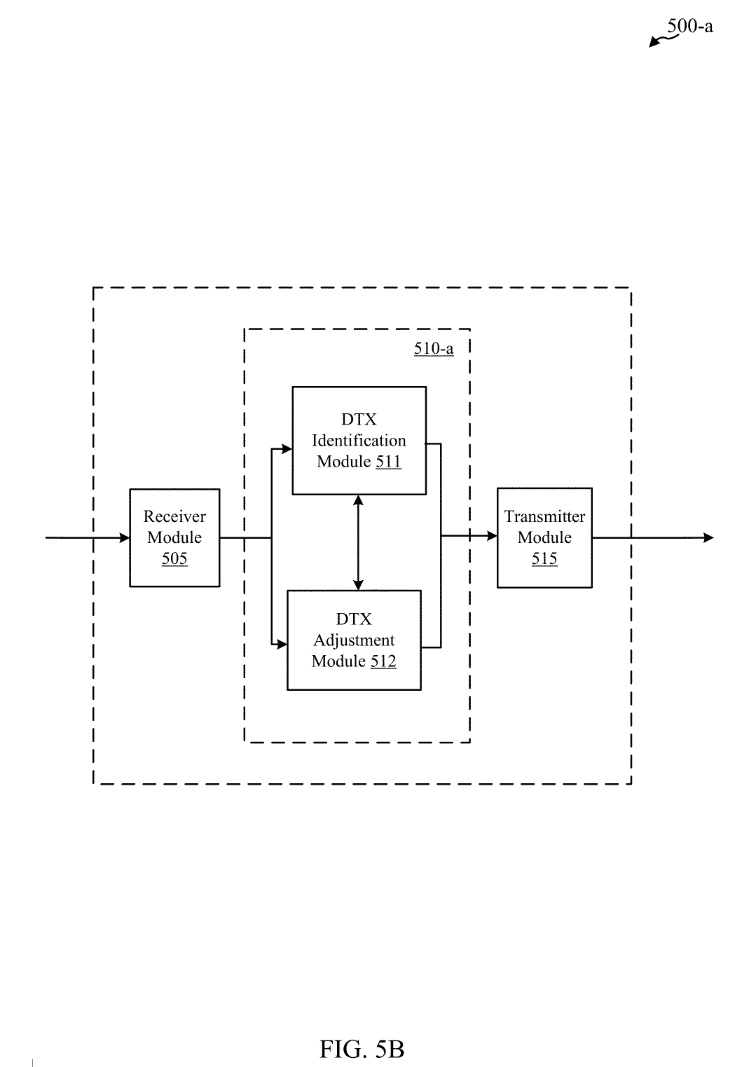

Turning next to FIG. 5A, a block diagram illustrates a device 500 that includes DTX functionality in a system that utilizes one or more flexible bandwidth carriers in accordance with various embodiments. The device 500 may be an example of aspects of: the base stations 105 of FIG. 1, FIG. 2A, FIG. 2B, and/or FIG. 3, and/or the user equipment 115 of FIG. 1, FIG. 2A, FIG. 2B, and/or FIG. 3, and/or the controller 120/core network 130 of FIG. 1; and or aspects of systems 400-a, 400-b, 400-c, and/or 400-d, of FIGS. 4A, 4B, 4C, and/or 4D. The device 500 may include a receiver module 505, a DTX alignment module 510, and a transmitter module 515. Each of these components may be in communication with each other. In some cases, device 500 may be a UE, such as UE 115 of FIG. 1, FIG. 2A, FIG. 2B, and/or FIG. 3.

These components of the device 500 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive information such as packet, data, and/or signaling information regarding what device 500 has received. The received information may be utilized by the device 500 for different purposes. The transmitter module 515 may transmit information such as packets, data, or signaling information regarding what device 500 has processed. The transmitted information may be utilized by various network entities for different purposes, as described below.

The DTX alignment module 510 may be configured to perform a method of DTX in a system that utilizes one or more flexible bandwidth carriers. For example, the DTX alignment module 510 may be configured to identify at least a DTX cycle for a first cell or a DTX cycle for a second cell, with at least the first cell or the second cell utilizing at least one or more flexible bandwidth carriers. The DTX alignment module 510 may further be configured to adjust one or more DTX parameters for at least the first cell or the second cell to align the DTX cycle for the second cell with the DTX cycle for the first cell such that the DTX cycle for the second cell at least partially overlaps the DTX cycle for the first cell.

In some cases, the DTX alignment module 510 may be further configured to align a starting boundary of the DTX cycle for the second cell with a starting boundary of the DTX cycle for the first cell as part of adjusting the one or more DTX parameters to align the DTX cycle for the second cell with the DTX cycle for the first cell. In some cases, the one or more DTX parameters may include at least an enabling delay, a DTX cycle length, a DTX-DRX offset, an inactivity threshold, or a preamble length. In some cases, the DTX alignment module 510 may base the adjustment of the one or more DTX parameters, at least in part on, interpreting the one or more DTX parameters relative to a bandwidth scaling factor of the first cell. In some cases, adjusting the one or more DTX parameters by the DTX alignment module 510 may include interpreting the one or more DTX parameters relative to another bandwidth scaling factor, where the another bandwidth scaling factor may be determined by comparing at least a bandwidth scaling factor of the first cell and a bandwidth scaling factor of the second cell. In yet other cases, adjusting the one or more DTX parameters by the DTX alignment module 510 may include interpreting the one or more DTX parameters relative to at least a highest bandwidth scaling factor or a lowest bandwidth scaling factor, the highest bandwidth scaling factor or the lowest bandwidth scaling factor determined by comparing at least a bandwidth scaling factor of the first cell and a bandwidth scaling factor of the second cell.

In some embodiments, the first cell may include a normal bandwidth carrier and the second cell may include one or more flexible bandwidth carriers. In some embodiments, the first cell may include a flexible bandwidth carrier and the second cell may include one or more flexible bandwidth carriers different from the first cell. In some cases, the flexible bandwidth of the first cell may be greater than the flexible bandwidth of the second cell.

In some embodiments, the first cell may include one or more flexible bandwidth carriers and the second cell may include a normal bandwidth carrier. In some embodiments, the first cell may include one or more flexible bandwidth carriers and the second cell may include one or more flexible bandwidth carriers different from the first cell. In some cases, the flexible bandwidth of the first cell may be less than the flexible bandwidth of the second cell.

In some embodiments, the first cell may include a bandwidth scaling factor equal to 1 and the second cell includes a bandwidth scaling factor equal to 2 or 4. In other embodiments, the first cell includes a bandwidth scaling factor equal to 2 or 4 and the second cell includes a bandwidth scaling factor equal to 1.

Turning next to FIG. 5B, a block diagram illustrates a device 500-a that includes DTX functionality in a system that utilizes one or more flexible bandwidth carriers in accordance with various embodiments. The device 500-a may be an example of aspects of: the base stations 105 of FIG. 1, FIG. 2A, FIG. 2B, and/or FIG. 3, the user equipment 115 of FIG. 1, FIG. 2A, FIG. 2B, and/or FIG. 3, and/or the controller 120/core network 130 of FIG. 1; and or aspects of 400-a, 400-b, 400-c, and/or 400-d of FIGS. 4A, 4B, 4C, and/or 4D.

The device 500-a may include a receiver module 505, a DTX identification module 511, a DTX adjustment module 512, and a transmitter module 515. Each of these components may be in communication with each other. In some embodiments, the DTX alignment module 510-a, which may incorporate some or all aspects of the DTX alignment module 510 of FIG. 5A, may include the DTX identification module 511 and the DTX adjustment module 512. Device 500-a, which may be a UE 115, may include some or all aspects of, or may implement some or all of the functionality of, device 500 as described above in reference to FIG. 5A.

The components of the device 500-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive information such as packet, data, and/or signaling information regarding what device 500-a has received. The received information may be utilized by the device 500-a for different purposes. The transmitter module 515 may transmit information such as packets, data, or signaling information regarding what device 500-a has processed. The transmitted information may be utilized by various network entities for different purposes as described herein.

As described above in reference to FIGS. 4A-4D, DTX misalignment across cells can cause an increase/ineffective utilization of power resources, particularly by a UE 115, because, for instance, the transmitter module 515 is required to transmit for longer periods of time/re-transmit uncoordinated DTX bursts across multiple cells having different bandwidth scaling factors. To account for uncoordinated DTX signaling, the DTX identification module 511 may be configured to identify at least a DTX cycle for a first cell or a DTX cycle for a second cell in a system that utilizes one or more flexible bandwidth carriers. The DTX adjustment module 512 may be configured to adjust one or more DTX parameters for at least the first cell or the second cell to align the DTX cycle for the second cell with the DTX cycle for the first cell such that the DTX cycle for the second cell at least partially overlaps the DTX cycle for the first cell.

In some cases, the DTX adjustment module 512 may be further configured to align a starting boundary of the DTX cycle for the second cell with a starting boundary of the DTX cycle for the first cell as part of adjusting the one or more DTX parameters to align the DTX cycle for the second cell with the DTX cycle for the first cell. In some cases, the one or more DTX parameters may include at least an enabling delay, a DTX cycle length, a DTX-DRX offset, an inactivity threshold, or a preamble length. Furthermore, the DTX adjustment module 512 may interpret the one or more DTX parameters relative to a bandwidth scaling factor of the first cell as part of the adjusting.

In some embodiments, adjusting the one or more DTX parameters by the DTX adjustment module 512 may include interpreting the one or more DTX parameters relative to another bandwidth scaling factor, where the another bandwidth scaling factor may be determined by comparing at least a bandwidth scaling factor of the first cell and a bandwidth scaling factor of the second cell, communicated to the DTX adjustment module 512 by the DTX identification module 511. In yet other cases, adjusting the one or more DTX parameters by the DTX adjustment module 512 may include interpreting the one or more DTX parameters relative to at least a highest bandwidth scaling factor or a lowest bandwidth scaling factor, the highest bandwidth scaling factor or the lowest bandwidth scaling factor determined by comparing at least a bandwidth scaling factor of the first cell and a bandwidth scaling factor of the second cell. In some cases, a bandwidth scaling factor of the first cell and a bandwidth scaling factor of the second cell may be communicated to the DTX adjustment module 512 via the receiver module 505 and/or the DTX identification module 511.

In some embodiments, the DTX identification module 511 and/or the DTX adjustment module 512 may be located at a UE 115. The receiver module 505 and/or the transmitter module 515 may also be located at the UE 115. In other embodiments, the receiver module 505, the DTX identification module 511, the DTX adjustment module 512, and/or the transmitter module 15 may be located at different network entities and may coordinate via the backhaul, air interfaces, etc.

In some embodiments, the first cell includes a normal bandwidth carrier and the second cell may include one or more flexible or scalable bandwidth carriers. In some embodiments, the first cell may include a flexible bandwidth carrier and the second cell may include one or more flexible bandwidth carriers different from the first cell. In some cases, the flexible bandwidth of the first cell is greater than the flexible bandwidth of the second cell.

In some embodiments, the first cell includes one or more flexible bandwidth carriers and the second cell includes a normal bandwidth carrier. In some embodiments, the first cell includes one or more flexible bandwidth carriers and the second cell includes one or more flexible bandwidth carriers different from the first cell. In some cases, the flexible bandwidth of the first cell is less than the flexible bandwidth of the second cell.

In some embodiments, the first cell includes a bandwidth scaling factor equal to 1 and the second cell includes a bandwidth scaling factor equal to 2 or 4. In other embodiments, the first cell includes a bandwidth scaling factor equal to 2 or 4 and the second cell includes a bandwidth scaling factor equal to 1.

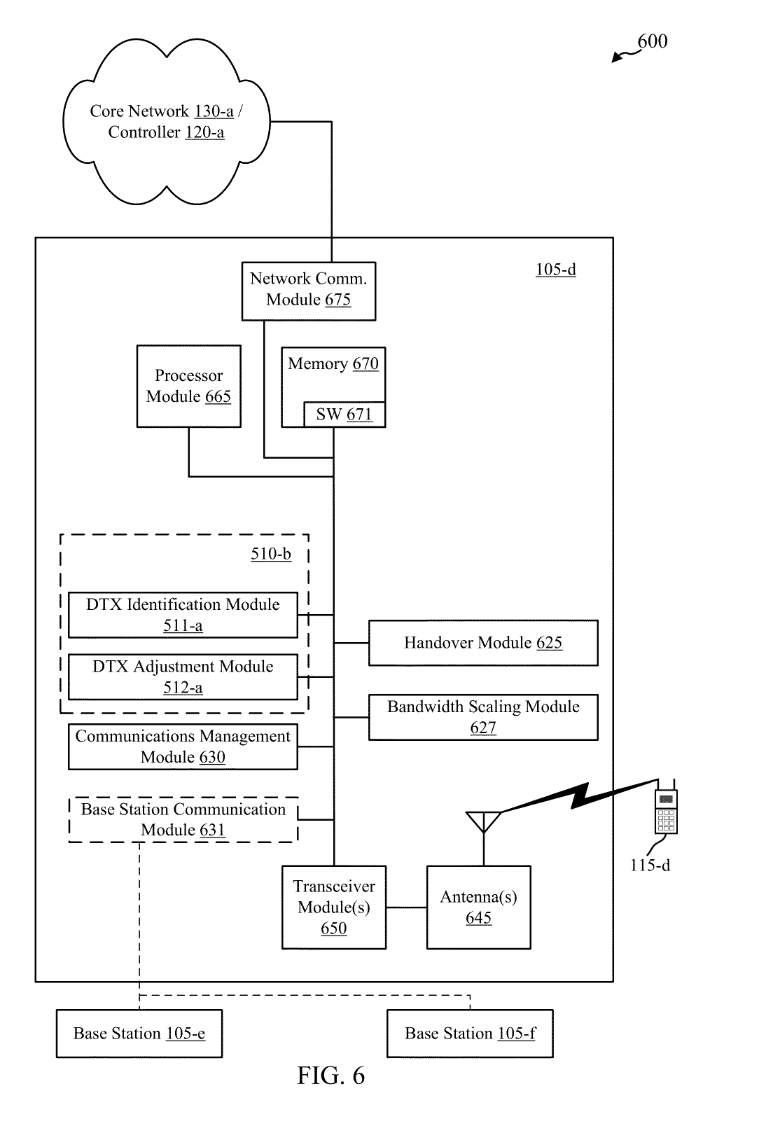

FIG. 6 shows a block diagram of a communications system 600 that may be configured for DTX in a system that utilizes one or more flexible bandwidth carriers in accordance with various embodiments. This system 600 may include aspects of the system 100 depicted in FIG. 1, systems 200-a and 200-b of FIGS. 2A and 2B, system 300 of FIG. 3, and/or systems 400-a, 400-b, 400-c, and/or 400-d of FIGS. 4A, 4B, 4C, and/or 4D; and/or devices 500 and 500-a of FIGS. 5A and/or 5B. The base station 105-d may include aspects of a controller 120-a and/or a core network 130-a in some cases. The base station 105-d may include antennas 645, a transceiver module 650, memory 670, and a processor module 665, which each may be in communication, directly or indirectly, with each other (e.g., over one or more buses). The transceiver module 650 may be configured to communicate bi-directionally, via the antennas 645, with the user equipment 115-d, which may be a multi-mode user equipment. The transceiver module 650 (and/or other components of the base station 105-d) may also be configured to communicate bi-directionally with one or more networks. In some cases, the base station 105-d may communicate with the network 130-a through network communications module 675. Base station 105-d may be an example of an eNodeB base station, a Home eNodeB base station, a NodeB base station, a Radio Network Controller (RNC), and/or a Home NodeB base station.

Base station 105-d may also communicate with other base stations 105, such as base station 105-e and base station 105-f. Each of the base stations 105 may communicate with user equipment 115-d using different wireless communications technologies, such as different Radio Access Technologies. In some cases, base station 105-d may communicate with other base stations such as 105-e and/or 105-f utilizing base station communication module 631. In some embodiments, base station communication module 631 may provide an X2 interface within an LTE wireless communication technology to provide communication between some of the base stations 105. In some embodiments, base station 105-d may communicate with other base stations through controller 120-a and/or network 130-a.

The memory 670 may include random access memory (RAM) and read-only memory (ROM). The memory 670 may also store computer-readable, computer-executable software code 671 containing instructions that are configured to, when executed, cause the processor module 665 to perform various functions described herein (e.g., call processing, database management, message routing, etc.). Alternatively, the software 671 may not be directly executable by the processor module 665 but be configured to cause the computer, e.g., when compiled and executed, to perform functions described herein.

The processor module 665 may include an intelligent hardware device, e.g., a central processing unit (CPU) such as those made by Intel® Corporation or AMD®, a microcontroller, an application-specific integrated circuit (ASIC), etc. The processor module 665 may include a speech encoder (not shown) configured to receive audio via a microphone, convert the audio into packets (e.g., 20 ms in length) representative of the received audio, provide the audio packets, and/or provide indications of whether a user is speaking.

The transceiver module 650 may include a modem configured to modulate the packets and provide the modulated packets to the antennas 645 for transmission, and to demodulate packets received from the antennas 645. While some examples of the base station 105-d may include a single antenna 645, the base station 105-d preferably includes multiple antennas 645 for multiple links which may support carrier aggregation. For example, one or more links may be used to support macro communications with user equipment 115-d.

According to the architecture of FIG. 6, the base station 105-d may further include a communications management module 630. By way of example, the communications management module 630 may be a component of the base station 105-d in communication with some or all of the other components of the base station 105-d via a bus. Alternatively, functionality of the communications management module 630 may be implemented as a component of the transceiver module 650, as a computer program product, and/or as one or more controller elements of the processor module 665.

The components for base station 105-d may be configured to implement aspects discussed above with respect to device 500 of FIG. 5A and/or device 500-a of FIG. 5B and/or configurations of systems 400-a, 400-b, 400-c, and/or 400-d of FIGS. 4A, 4B, 4C, and/or 4D, and may not be repeated here for the sake of brevity. The DTX identification module 511-a may be an example of the DTX identification module 511 of FIG. 5B. The DTX adjustment module 512-a may be an example of the DTX adjustment module 512 of FIG. 5B. Furthermore, DTX alignment module 510-b, which may include the DTX identification module 511-a and the DTX adjustment module 512-a, may be an example of the DTX alignment module 510 of FIG. 5A and/or the DTX alignment module 510-a of FIG. 5B.

The base station 105-d may also include a spectrum identification module (not shown). The spectrum identification module may be utilized to identify spectrum available for flexible bandwidth waveforms. In some embodiments, a handover module 625 may be utilized to perform handover procedures of the user equipment 115-d from one base station 105 to another. For example, the handover module 625 may perform a handover procedure of the user equipment 115-d from base station 105-d to another where normal waveforms are utilized between the user equipment 115-d and one of the base stations and flexible bandwidth waveforms are utilized between the user equipment and another base station. A bandwidth scaling module 627 may be utilized to scale and/or alter chip rates and/or time to generate flexible bandwidth waveforms. In some cases, base station 105-d may be configured may utilize normal bandwidth forms or may be provisioned for specific flexible bandwidth waveforms.

In some embodiments, the transceiver module 650 in conjunction with antennas 645, along with other possible components of base station 105-d, may transmit and/or receive information regarding flexible bandwidth waveforms and/or scaling factors from the base station 105-d to the user equipment 115-d, to other base stations 105-e/105-f, or core network 130-a. In some embodiments, the transceiver module 650 in conjunction with antennas 645, along with other possible components of base station 105-d, may transmit and/or receive information to or from the user equipment 115-d, to or from other base stations 105-e/105-f, or core network 130-a, such as flexible bandwidth waveforms and/or scaling factors, such that these devices or systems may utilize flexible bandwidth waveforms.

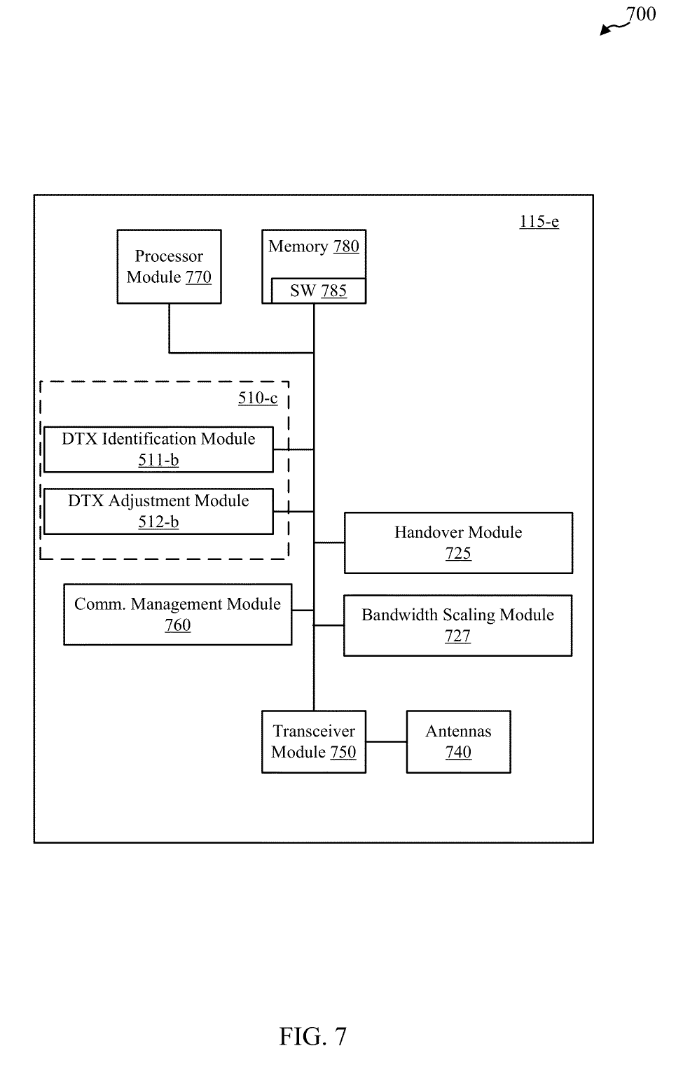

FIG. 7 is a block diagram 700 of a user equipment 115-e configured in accordance with various embodiments. The user equipment 115-e may have any of various configurations, such as personal computers (e.g., laptop computers, netbook computers, tablet computers, etc.), cellular telephones, PDAs, digital video recorders (DVRs), internet appliances, gaming consoles, e-readers, etc. The user equipment 115-e may have an internal power supply (not shown), such as a small battery, to facilitate mobile operation. In some embodiments, the user equipment 115-e may implement aspects of the system 100 depicted in FIG. 1, systems 200-a and 200-b of FIGS. 2A and 2B, system 300 of FIG. 3, systems 400-a, 400-b, 400-c, and/or 400-d of FIGS. 4A, 4B, 4C, and/or 4D, and/or system 600 of FIG. 6; and/or devices 500 and 500-a of FIGS. 5A and/or 5B. The user equipment 115-e may be a multi-mode user equipment. The user equipment 115-e may further be referred to as a wireless communications device in some cases.

The user equipment 115-e may include antennas 740, a transceiver module 750, memory 780, and a processor module 770, which each may be in communication, directly or indirectly, with each other (e.g., via one or more buses). The transceiver module 750 is configured to communicate bi-directionally, via the antennas 740 and/or one or more wired or wireless links, with one or more networks, as described above. For example, the transceiver module 750 may be configured to communicate bi-directionally with base stations 105 of FIG. 1, FIGS. 2A and 2B, FIG. 3, and/or FIG. 6, and/or with devices 500 and 500-a of FIGS. 5A and 5B. The transceiver module 750 may include a modem configured to modulate the packets and provide the modulated packets to the antennas 740 for transmission, and to demodulate packets received from the antennas 740. While the user equipment 115-e may include a single antenna, the user equipment 115-e will typically include multiple antennas 740 for multiple links.

The memory 780 may include random access memory (RAM) and read-only memory (ROM). The memory 780 may store computer-readable, computer-executable software code 785 containing instructions that are configured to, when executed, cause the processor module 770 to perform various functions described herein (e.g., call processing, database management, message routing, etc.). Alternatively, the software 785 may not be directly executable by the processor module 770 but may be configured to cause the computer (e.g., when compiled and executed) to perform functions described herein.

The processor module 770 may include an intelligent hardware device, e.g., a central processing unit (CPU) such as those made by Intel® Corporation or AMD®, a microcontroller, an application-specific integrated circuit (ASIC), etc. The processor module 770 may include a speech encoder (not shown) configured to receive audio via a microphone, convert the audio into packets (e.g., 20 ms in length) representative of the received audio, provide the audio packets to the transceiver module 750, and provide indications of whether a user is speaking. Alternatively, an encoder may only provide packets to the transceiver module 750, with the provision or withholding/suppression of the packet itself providing the indication of whether a user is speaking. The processor module 770 may also include a speech decoder that may perform a reverse functionality as the speech encoder.

According to the architecture of FIG. 7, the user equipment 115-e may further include a communications management module 760. The communications management module 760 may manage communications with other user equipments 115. By way of example, the communications management module 760 may be a component of the user equipment 115-e in communication with some or all of the other components of the user equipment 115-e via a bus. Alternatively, functionality of the communications management module 760 may be implemented as a component of the transceiver module 750, as a computer program product, and/or as one or more controller elements of the processor module 770.

The components for user equipment 115-e may be configured to implement aspects discussed above with respect to device 500 of FIG. 5A and/or device 500-a of FIG. 5B, system 600 of FIG. 6, and/or configurations of systems 400-a, 400-b, 400-c, and/or 400-d of FIGS. 4A, 4B, 4C, and/or 4D, and may not be repeated here for the sake of brevity. The DTX identification module 511-b may be an example of the DTX identification module 511 of FIG. 5B. The DTX adjustment module 512-b may be an example of the DTX adjustment module 512 of FIG. 5B. Furthermore, DTX alignment module 510-c, which may include the DTX identification module 511-b and the DTX adjustment module 512-b, may be an example of the DTX alignment module 510 of FIG. 5A and/or the DTX alignment module 510-a of FIG. 5B.

The user equipment 115-e may also include a spectrum identification module (not shown). The spectrum identification module may be utilized to identify spectrum available for flexible bandwidth waveforms. In some embodiments, a handover module 725 may be utilized to perform handover procedures of the user equipment 115-e from one base station to another. For example, the handover module 725 may perform a handover procedure of the user equipment 115-e from one base station to another where normal waveforms are utilized between the user equipment 115-e and one of the base stations and flexible bandwidth waveforms are utilized between the user equipment and another base station. A bandwidth scaling module 77 may be utilized to scale and/or alter chip rates and/or time to generate/decode flexible bandwidth waveforms.

In some embodiments, the transceiver module 750, in conjunction with antennas 740, along with other possible components of user equipment 115-e, may transmit information regarding flexible bandwidth waveforms and/or scaling factors from the user equipment 115-e to base stations or a core network. In some embodiments, the transceiver module 750, in conjunction with antennas 740, along with other possible components of user equipment 115-e, may transmit/receive information, such flexible bandwidth waveforms and/or scaling factors, to/from base stations or a core network such that these devices or systems may utilize flexible bandwidth waveforms.

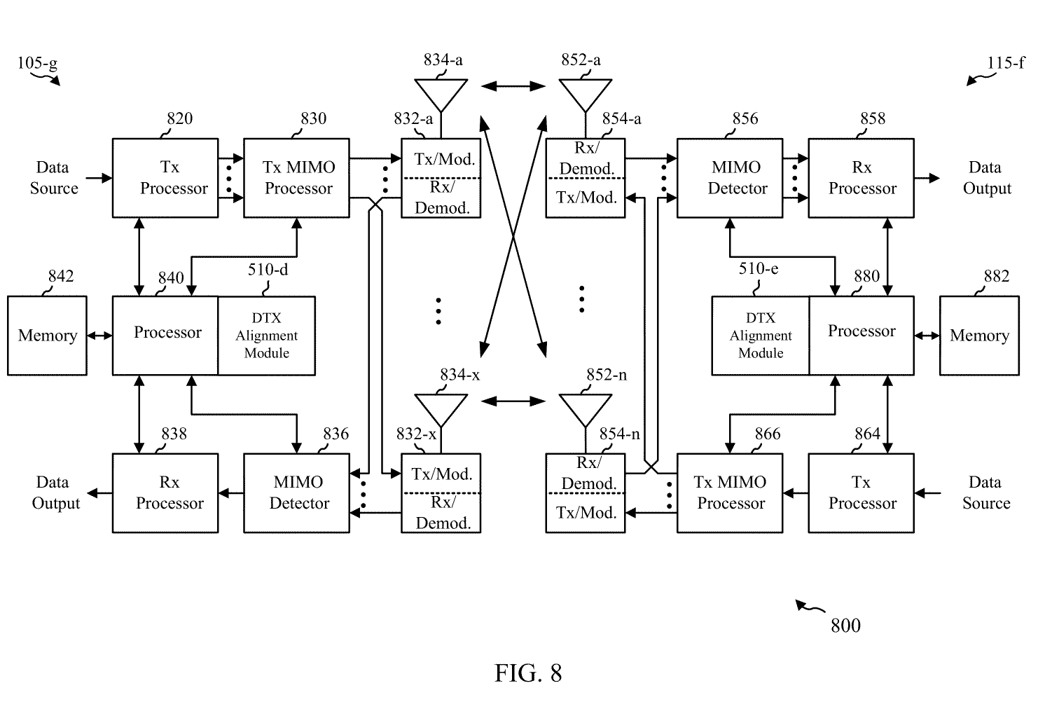

FIG. 8 is a block diagram of a system 800 including a base station 105-g and a user equipment 115-f in accordance with various embodiments. The system 800 may be an example of the system 100 of FIG. 1, systems 200-a and 200-b of FIGS. 2A and 2B, system 300 of FIG. 3, system 600 of FIG. 6, system 700 of FIG. 7, and/or devices 500 and 500-a of FIGS. 5A and 5B. The base station 105-g may be equipped with antennas 834-a through 834-x, and the user equipment 115-f may be equipped with antennas 852-a through 852-n. At the base station 105-g, a transmit processor 820 may receive data from a data source. System 800 may be configured to implement different aspects of configurations shown in FIGS. 4A, 4B, 4C, and/or 4D and the associated descriptions.

The transmit processor 820 may process the data. The transmit processor 820 may also generate reference symbols, and a cell-specific reference signal. A transmit (TX) MIMO processor 830 may perform spatial processing (e.g., precoding) on data symbols, control symbols, and/or reference symbols, if applicable, and may provide output symbol streams to the transmit modulators 832-a through 832-x. Each modulator 832 may process a respective output symbol stream (e.g., for OFDM, etc.) to obtain an output sample stream. Each modulator 832 may further process (e.g., convert to analog, amplify, filter, and upconvert) the output sample stream to obtain a downlink (DL) signal. In one example, DL signals from modulators 832-a through 832-x may be transmitted via the antennas 834-a through 834-x, respectively. The transmit processor 820 may receive information from a processor 840. The processor 840 may be coupled with a memory 842. The processor 840 may be configured to generate flexible bandwidth waveforms through altering a chip rate and/or utilizing a scaling factor. In some embodiments, the processor module 840 may be configured for dynamically adapting flexible bandwidth in accordance with various embodiments. The processor 840 may dynamically adjust one or more scale factors of the flexible bandwidth signal associated with transmissions between base station 105-g and user equipment 115-f. These adjustments may be made based on information such as traffic patterns, interference measurements, etc.

For example, within system 800, the processor 840 may further include a DTX alignment module 510-d configured to identify at least a DTX cycle for a first cell or a DTX cycle for a second cell in a system that utilizes one or more flexible bandwidth carriers. The DTX alignment module 510-d may further be configured to adjust one or more DTX parameters for at least the first cell or the second cell to align the DTX cycle for the second cell with the DTX cycle for the first cell such that the DTX cycle for the second cell at least partially overlaps the DTX cycle for the first cell. The DTX alignment module 510-d may be an example of or may incorporate aspects of the DTX alignment module 510, 510-a, 510-b, and 510-c of FIGS. 5A, 5B, 6, and/or 7.

At the user equipment 115-f, the user equipment antennas 852-a through 852-n may receive the DL signals from the base station 105-g and may provide the received signals to the demodulators 854-a through 854-n, respectively. Each demodulator 854 may condition (e.g., filter, amplify, downconvert, and digitize) a respective received signal to obtain input samples. Each demodulator 854 may further process the input samples (e.g., for OFDM, etc.) to obtain received symbols. A MIMO detector 856 may obtain received symbols from all the demodulators 854-a through 854-n, perform MIMO detection on the received symbols, if applicable, and provide detected symbols. A receive processor 858 may process (e.g., demodulate, deinterleave, and decode) the detected symbols, providing decoded data for the user equipment 115-f to a data output, and provide decoded control information to a processor 880, or memory 882.

On the uplink (UL) or reverse link, at the user equipment 115-f, a transmit processor 864 may receive and process data from a data source. The transmitter processor 864 may also generate reference symbols for a reference signal. The symbols from the transmit processor 864 may be precoded by a transmit MIMO processor 866, if applicable, further processed by the demodulators 854-a through 854-n (e.g., for SC-FDMA, etc.), and be transmitted to the base station 105-g in accordance with the transmission parameters received from the base station 105-g. The transmit processor 864 may also be configured to generate flexible bandwidth waveforms through altering a chip rate and/or utilizing a scaling factor; this may be done dynamically in some cases. The transmit processor 864 may receive information from processor 880. The processor 880 may provide for different alignment and/or offsetting procedures. The processor 880 may also utilize scaling and/or chip rate information to perform measurements on the other subsystems, perform handoffs to the other subsystems, perform reselection, etc. The processor 880 may invert the effects of time stretching associated with the use of flexible bandwidth through parameter scaling. At the base station 105-g, the UL signals from the user equipment 115-f may be received by the antennas 834, processed by the demodulators 832, detected by a MIMO detector 836, if applicable, and further processed by a receive processor 838. The receive processor 838 may provide decoded data to a data output and to the processor 840. In some embodiments, the processor 840 may be implemented as part of a general processor, the transmit processor 830, and/or the receiver processor 838.

In some embodiments, the processor module 880 may be configured for dynamically adapting flexible bandwidth in accordance with various embodiments. The processor 880 may dynamically adjust one or more scale factors of the flexible bandwidth signal associated with transmissions between base station 105-g and user equipment 115-f. These adjustments may be made based on information such as traffic patterns, interference measurements, etc.

For example, within system 800, the processor 880 may further include a DTX alignment module 510-e configured to identify at least a DTX cycle for a first cell or a DTX cycle for a second cell, where at least one of the first cell or the second cell includes a flexible bandwidth carrier. The DTX alignment module 510-e may further be configured to adjust one or more DTX parameters for at least the first cell or the second cell to align the DTX cycle for the second cell with the DTX cycle for the first cell such that the DTX cycle for the second cell at least partially overlaps the DTX cycle for the first cell. The DTX alignment module 510-d may be an example of or may incorporate aspects of DTX alignment module 510, 510-a, 510-b, and 510-c of FIGS. 5A, 5B, 6, and/or 7. Furthermore, the DTX alignment module 510-e may coordinate and/or share functionality with the DTX alignment module 510-d.

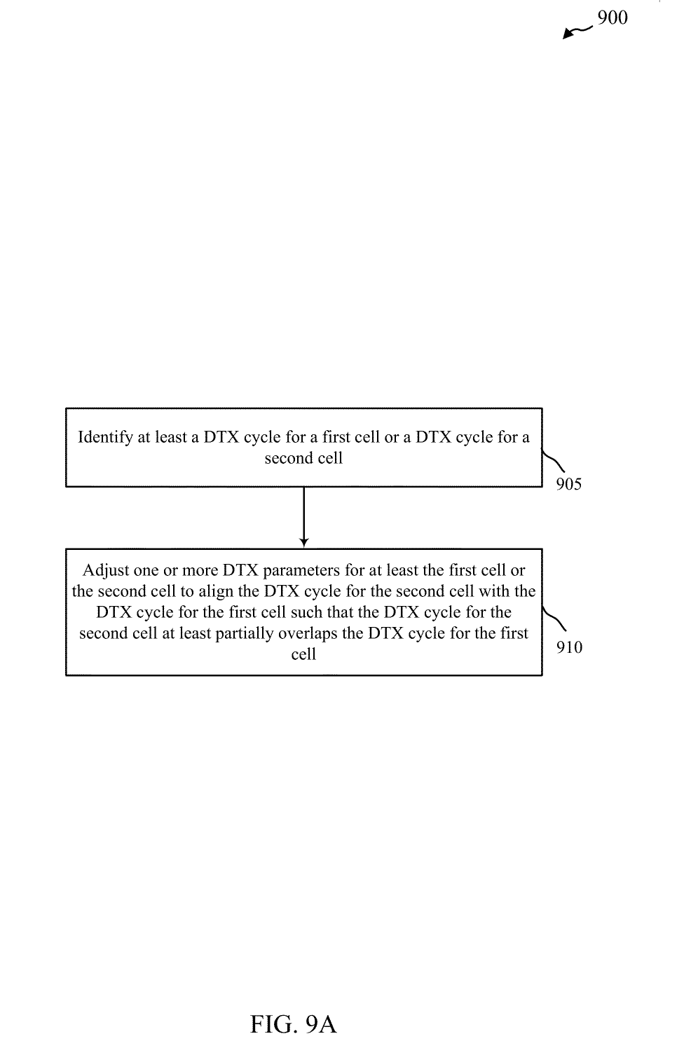

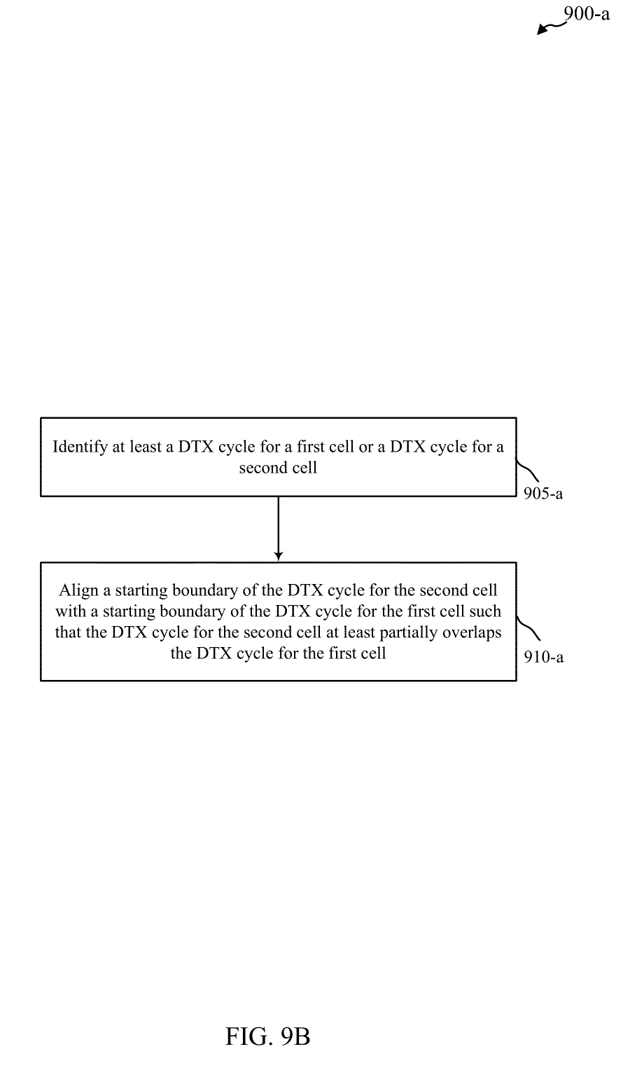

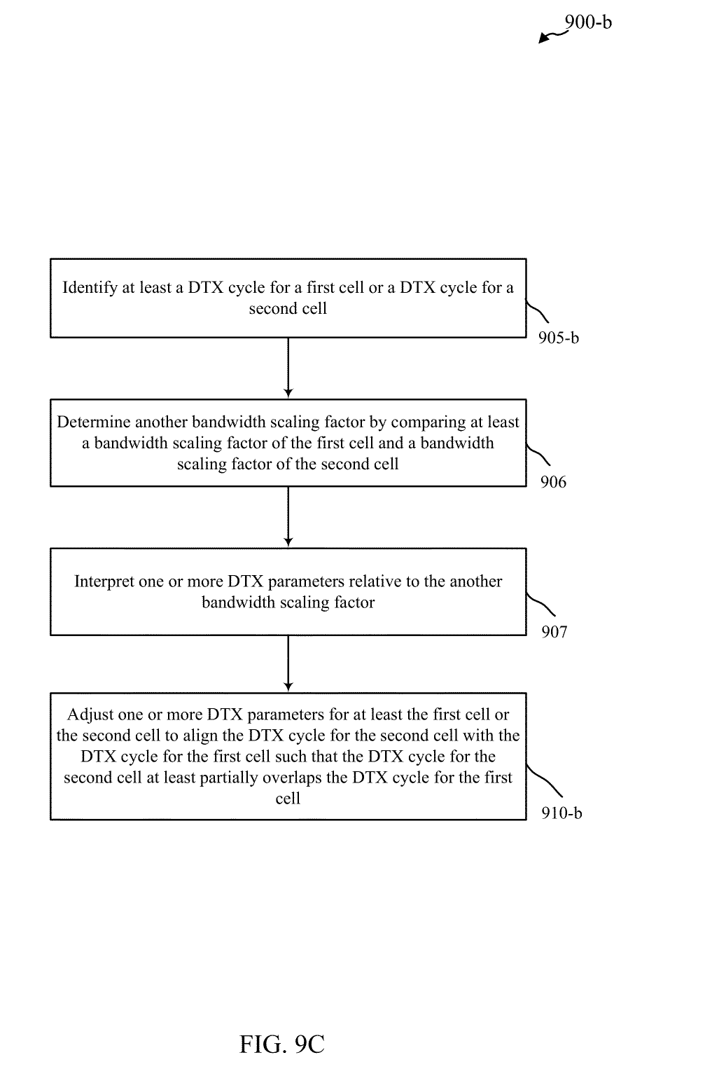

Turning to FIG. 9A, a flow diagram of a method 900 for DTX in a system that utilizes one or more flexible bandwidth carriers is provided in accordance with various embodiments. Method 900 may be implemented utilizing various wireless communications devices and/or systems including, but not limited to: system 100 of FIG. 1, systems 200-a and 200-b of FIGS. 2A and 2B, system 300 of FIG. 3, systems 400-a, 400-b, 400-c, and/or 400-d of FIGS. 4A, 4B, 4C, and/or 4D, system 600 of FIG. 6, system 700 of FIG. 7, and/or system 800 of FIG. 8; the base stations 105 of FIG. 1, FIG. 2A, FIG. 2B, FIG. 3, FIG. 6, and/or FIG. 8; the user equipment 115 of FIG. 1, FIG. 2A, FIG. 2B, FIG. 3, FIG. 6, FIG. 7, and/or FIG. 8; the controller 120/core network 130 of FIGS. 1 and/or 6; and/or devices 500 and 500-a of FIGS. 5A and 5B.

At block 905, at least a DTX cycle for a first cell or a DTX cycle for a second cell may be identified. At block 910, one or more DTX parameters for at least the first cell or the second cell may be adjusted to align the DTX cycle for the second cell with the DTX cycle for the first cell such that the DTX cycle for the second cell at least partially overlaps the DTX cycle for the first cell.

In some embodiments, a starting boundary of the DTX cycle for the second cell may be aligned with a starting boundary of the DTX cycle for the first cell as part of adjusting the one or more DTX parameters to align the DTX cycle for the second cell with the DTX cycle for the first cell. In some cases, the one or more DTX parameters may include at least an enabling delay, a DTX cycle length, a DTX-DRX offset, an inactivity threshold, or a preamble length.

In some cases, the method 900 may further include interpreting the one or more DTX parameters relative to a bandwidth scaling factor of the first cell as part of the adjusting the one or more DTX parameters to align the DTX cycle for the second cell with the DTX cycle for the first cell. In some cases, adjusting the one or more DTX parameters may include interpreting the one or more DTX parameters relative to another bandwidth scaling factor, where the another bandwidth scaling factor may be determined by comparing at least a bandwidth scaling factor of the first cell and a bandwidth scaling factor of the second cell. In yet other cases, adjusting the one or more DTX parameters may include interpreting the one or more DTX parameters relative to at least a highest bandwidth scaling factor or a lowest bandwidth scaling factor, the highest bandwidth scaling factor or the lowest bandwidth scaling factor determined by comparing at least a bandwidth scaling factor of the first cell and a bandwidth scaling factor of the second cell.

In some embodiments, the first cell may include a normal bandwidth carrier and the second cell may include one or more flexible bandwidth carriers. In other embodiments, the first cell may include a flexible bandwidth carrier and the second cell may include one or more flexible bandwidth carriers different from the first cell. In some cases, the flexible bandwidth of the first cell is greater than the flexible bandwidth of the second cell.

The methods for DTX can also be beneficially implemented when the first cell may include one or more flexible bandwidth carriers and the second cell may include a normal bandwidth carrier. In some cases, the first cell may include one or more flexible bandwidth carriers and the second cell may include one or more flexible bandwidth carriers different from the first cell. The flexible bandwidth of the first cell may be less than the flexible bandwidth of the second cell.

In yet other cases, the methods described can be implemented where the first cell includes a bandwidth scaling factor equal to 1 and the second cell includes a bandwidth scaling factor equal to 2 or 4. In some cases, the first cell may include a bandwidth scaling factor equal to 2 or 4 and the second cell may include a bandwidth scaling factor equal to 1. In some cases, a scaling factor of the first cell is different from a scaling factor of the second cell. In some cases, the first cell may include a bandwidth scaling factor equal to 1, 2, or 4 and the second cell may include a bandwidth scaling factor equal to 1, 2, or 4.

Turning to FIG. 9B, a flow diagram of a method 900-a for DTX in a system that utilizes one or more flexible bandwidth carriers is provided in accordance with various embodiments. Method 900-a may be implemented utilizing various wireless communications devices and/or systems including, but not limited to: system 100 of FIG. 1, systems 200-a and 200-b of FIGS. 2A and 2B, system 300 of FIG. 3, systems 400-a, 400-b, 400-c, and/or 400-d of FIGS. 4A, 4B, 4C, and/or 4D, system 600 of FIG. 6, system 700 of FIG. 7, and/or system 800 of FIG. 8; the base stations 105 of FIG. 1, FIG. 2A, FIG. 2B, FIG. 3, FIG. 6, and/or FIG. 8; the user equipment 115 of FIG. 1, FIG. 2A, FIG. 2B, FIG. 3, FIG. 6, FIG. 7, and/or FIG. 8; the controller 120/core network 130 of FIGS. 1 and/or 6; and/or devices 500 and 500-a of FIGS. 5A and 5B. Method 900-a may be an example of method 900 of FIG. 9A.

At block 905-a, at least a DTX cycle for a first cell or a DTX cycle for a second cell may be identified. At block 910-a, a starting boundary of the DTX cycle for the second cell may be aligned with a starting boundary of the DTX cycle for the first cell such that the DTX cycle for the second cell at least partially overlaps the DTX cycle for the first cell.

In some embodiments, the first cell may include a normal bandwidth carrier and the second cell may include one or more flexible bandwidth carriers. In other embodiments, the first cell may include a flexible bandwidth carrier and the second cell may include one or more flexible bandwidth carriers different from the first cell. In some cases, the flexible bandwidth of the first cell is greater than the flexible bandwidth of the second cell.

The methods for DTX can also be beneficially implemented when the first cell may include one or more flexible bandwidth carriers and the second cell may include a normal bandwidth carrier. In some cases, the first cell may include one or more flexible bandwidth carriers and the second cell may include one or more flexible bandwidth carriers different from the first cell. The flexible bandwidth of the first cell may be less than the flexible bandwidth of the second cell.

In yet other cases, the methods described can be implemented where the first cell includes a bandwidth scaling factor equal to 1 and the second cell includes a bandwidth scaling factor equal to 2 or 4. In some cases, the first cell may include a bandwidth scaling factor equal to 2 or 4 and the second cell may include a bandwidth scaling factor equal to 1. In some cases, a scaling factor of the first cell is different from a scaling factor of the second cell. In some cases, the first cell may include a bandwidth scaling factor equal to 1, 2, or 4 and the second cell may include a bandwidth scaling factor equal to 1, 2, or 4.

Turning to FIG. 9C, a flow diagram of a method 900-b for DRX in a system that utilizes one or more flexible bandwidth carriers is provided in accordance with various embodiments. Method 900-b may be implemented utilizing various wireless communications devices and/or systems including, but not limited to: system 100 of FIG. 1, systems 200-a and 200-b of FIGS. 2A and 2B, system 300 of FIG. 3, systems 400-a, 400-b, 400-c, and/or 400-d of FIGS. 4A, 4B, 4C, and/or 4D, system 600 of FIG. 6, system 700 of FIG. 7, and/or system 800 of FIG. 8; the base stations 105 of FIG. 1, FIG. 2A, FIG. 2B, FIG. 3, FIG. 6, and/or FIG. 8; the user equipment 115 of FIG. 1, FIG. 2A, FIG. 2B, FIG. 3, FIG. 6, FIG. 7, and/or FIG. 8; the controller 120/core network 130 of FIGS. 1 and/or 6; and/or devices 500 and 500-a of FIGS. 5A and 5B. Method 900-b may be an example of method 900 of FIG. 9A.

At block 905-b, at least a DTX cycle for a first cell or a DTX cycle for a second cell may be identified. At block 906, another bandwidth scaling factor may be determined by comparing at least a bandwidth scaling factor of the first cell and a bandwidth scaling factor of the second cell. At block 907, one or more DTX parameters relative to the another bandwidth scaling factor may be interpreted. At block 910-b, one or more DTX parameters for at least the first cell or the second cell may be adjusted to align the DTX cycle for the second cell with the DTX cycle for the first cell such that the DTX cycle for the second cell at least partially overlaps the DTX cycle for the first cell.

In some embodiments, the first cell may include a normal bandwidth carrier and the second cell may include one or more flexible bandwidth carriers. In other embodiments, the first cell may include a flexible bandwidth carrier and the second cell may include one or more flexible bandwidth carriers different from the first cell. In some cases, the flexible bandwidth of the first cell is greater than the flexible bandwidth of the second cell.

The methods for DTX can also be beneficially implemented when the first cell may include one or more flexible bandwidth carriers and the second cell may include a normal bandwidth carrier. In some cases, the first cell may include one or more flexible bandwidth carriers and the second cell may include one or more flexible bandwidth carriers different from the first cell. The flexible bandwidth of the first cell may be less than the flexible bandwidth of the second cell.

In yet other cases, the methods described can be implemented where the first cell includes a bandwidth scaling factor equal to 1 and the second cell includes a bandwidth scaling factor equal to 2 or 4. In some cases, the first cell may include a bandwidth scaling factor equal to 2 or 4 and the second cell may include a bandwidth scaling factor equal to 1. In some cases, a scaling factor of the first cell is different from a scaling factor of the second cell. In some cases, the first cell may include a bandwidth scaling factor equal to 1, 2, or 4 and the second cell may include a bandwidth scaling factor equal to 1, 2, or 4.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general-purpose or special-purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of discontinuous transmission (DTX) in a system that utilizes one or more flexible bandwidth carriers, the method comprising:
identifying at least a DTX cycle for a first cell or a DTX cycle for a second cell, wherein at least the first cell or the second cell utilizes at least one of the one or more flexible bandwidth carriers; and
adjusting one or more DTX parameters for at least the first cell or the second cell to align the DTX cycle for the second cell with the DTX cycle for the first cell such that the DTX cycle for the second cell at least partially overlaps the DTX cycle for the first cell.

2. The method of claim 1, wherein adjusting the one or more DTX parameters to align the DTX cycle for the second cell with the DTX cycle for the first cell comprises aligning a starting boundary of the DTX cycle for the second cell with a starting boundary of the DTX cycle for the first cell.

3. The method of claim 1, wherein the one or more DTX parameters comprises at least an enabling delay, a DTX cycle length, a DTX-DRX offset, an inactivity threshold, or a preamble length.

4. The method of claim 1, wherein adjusting the one or more DTX parameters comprises interpreting the one or more DTX parameters relative to a bandwidth scaling factor of the first cell.

5. The method of claim 1, wherein adjusting the one or more DTX parameters comprises interpreting the one or more DTX parameters relative to another bandwidth scaling factor, the another bandwidth scaling factor determined by comparing at least a bandwidth scaling factor of the first cell and a bandwidth scaling factor of the second cell.

6. The method of claim 1, wherein adjusting the one or more DTX parameters comprises interpreting the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

7. The method of claim 1, wherein the first cell comprises a normal bandwidth carrier and the second cell comprises one of the one or more flexible bandwidth carriers.

8. The method of claim 7, wherein the first cell comprises a bandwidth scaling factor equal to 1 and the second cell comprises a bandwidth scaling factor equal to 2 or 4.

9. The method of claim 1, wherein the first cell comprises one of the one or more flexible bandwidth carriers and the second cell comprises a normal bandwidth carrier.

10. The method of claim 9, wherein the first cell comprises a bandwidth scaling factor equal to 2 or 4 and the second cell comprises a bandwidth scaling factor equal to 1.

11. The method of claim 1, wherein a scaling factor of the first cell is different from a scaling factor of the second cell.

12. The method of claim 1, wherein the first cell comprises one of the one or more flexible bandwidth carriers and the second cell comprises another one of the one or more flexible bandwidth carriers different from the first cell.

13. A system for discontinuous transmission (DTX) that utilizes one or more flexible bandwidth carriers comprising:
means for identifying at least a DTX cycle for a first cell or a DTX cycle for a second cell, wherein at least the first cell or the second cell utilizes at least one of the one or more flexible bandwidth carriers; and
means for adjusting one or more DTX parameters for at least the first cell or the second cell to align the DTX cycle for the second cell with the DTX cycle for the first cell such that the DTX cycle for the second cell at least partially overlaps the DTX cycle for the first cell.

14. The system of claim 13, wherein the means for adjusting the one or more DTX parameters to align the DTX cycle for the second cell with the DTX cycle for the first cell comprises means for aligning a starting boundary of the DTX cycle for the second cell with a starting boundary of the DTX cycle for the first cell.

15. The system of claim 13, wherein the one or more DTX parameters comprises at least an enabling delay, a DTX cycle length, a DTX-DRX offset, an inactivity threshold, or a preamble length.

16. The system of claim 13, wherein the means for adjusting the one or more DTX parameters comprises means for interpreting the one or more DTX parameters relative to a bandwidth scaling factor of the first cell.

17. The system of claim 13, wherein the means for adjusting the one or more DTX parameters comprises means for interpreting the one or more DTX parameters relative to another bandwidth scaling factor, the another bandwidth scaling factor determined by comparing at least a bandwidth scaling factor of the first cell and a bandwidth scaling factor of the second cell.

18. The system of claim 13, wherein the means for adjusting the one or more DTX parameters comprises means for interpreting the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

19. The system of claim 13, wherein the first cell comprises a normal bandwidth carrier and the second cell comprises one of the one or more flexible bandwidth carriers.

20. The system of claim 19, wherein the first cell comprises a bandwidth scaling factor equal to 1 and the second cell comprises a bandwidth scaling factor equal to 2 or 4.

21. The system of claim 13, wherein the first cell comprises one of the one or more flexible bandwidth carriers and the second cell comprises a normal bandwidth carrier.

22. The system of claim 21, wherein the first cell comprises a bandwidth scaling factor equal to 2 or 4 and the second cell comprises a bandwidth scaling factor equal to 1.

23. The system of claim 13, wherein the first cell comprises one of the one or more flexible bandwidth carriers and the second cell comprises another one of the one or more flexible bandwidth carriers different from the first cell.

24. A computer program product for discontinuous transmission (DTX) in a system that utilizes one or more flexible bandwidth carriers, the computer program product comprising:
a non-transitory computer-readable medium comprising:
code for identifying at least a DTX cycle for a first cell or a DTX cycle for a second cell, wherein at least the first cell or the second cell utilizes at least one of the one or more flexible bandwidth carriers; and
code for adjusting one or more DTX parameters for at least the first cell or the second cell to align the DTX cycle for the second cell with the DTX cycle for the first cell such that the DTX cycle for the second cell at least partially overlaps the DTX cycle for the first cell.

25. The computer program product of claim 24, wherein the code for adjusting the one or more DTX parameters to align the DTX cycle for the second cell with the DTX cycle for the first cell comprises code for aligning a starting boundary of the DTX cycle for the second cell with a starting boundary of the DTX cycle for the first cell.

26. The computer program product of claim 24, wherein the one or more DTX parameters comprises at least an enabling delay, a DTX cycle length, a DTX-DRX offset, an inactivity threshold, or a preamble length.

27. The computer program product of claim 24, wherein the code for adjusting the one or more DTX parameters comprises code for interpreting the one or more DTX parameters relative to a bandwidth scaling factor of the first cell.

28. The computer program product of claim 24, wherein the code for adjusting the one or more DTX parameters comprises code for interpreting the one or more DTX parameters relative to another bandwidth scaling factor, the another bandwidth scaling factor determined by comparing at least a bandwidth scaling factor of the first cell and a bandwidth scaling factor of the second cell.

29. The computer program product of claim 24, wherein the code for adjusting the one or more DTX parameters comprises code for interpreting the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

30. The computer program product of claim 24, wherein the first cell comprises a normal bandwidth carrier and the second cell comprises one of the one or more flexible bandwidth carriers.

31. The computer program product of claim 30, wherein the first cell comprises a bandwidth scaling factor equal to 1 and the second cell comprises a bandwidth scaling factor equal to 2 or 4.

32. The computer program product of claim 24, wherein the first cell comprises one of the one or more flexible bandwidth carriers and the second cell comprises a normal bandwidth carrier.

33. The computer program product of claim 32, wherein the first cell comprises a bandwidth scaling factor equal to 2 or 4 and the second cell comprises a bandwidth scaling factor equal to 1.

34. The computer program product of claim 24, wherein the first cell comprises one of the one or more flexible bandwidth carriers and the second cell comprises another one of the one or more flexible bandwidth carriers different from the first cell.

35. A wireless communications device configured for discontinuous transmission (DTX) in a system that utilizes one or more flexible bandwidth carriers, the device comprising:
at least one processor configured to:
identify at least a DTX cycle for a first cell or a DTX cycle for a second cell, wherein at least the first cell or the second cell utilizes at least one of the one or more flexible bandwidth carriers; and
adjust one or more DTX parameters for at least the first cell or the second cell to align the DTX cycle for the second cell with the DTX cycle for the first cell such that the DTX cycle for the second cell at least partially overlaps the DTX cycle for the first cell.

36. The wireless communications device of claim 35, wherein the at least one processor is further configured to align a starting boundary of the DTX cycle for the second cell with a starting boundary of the DTX cycle for the first cell.

37. The wireless communications device of claim 35, wherein the one or more DTX parameters comprises at least an enabling delay, a DTX cycle length, a DTX-DRX offset, an inactivity threshold, or a preamble length.

38. The wireless communications device of claim 35, wherein the at least one processor is further configured to interpret the one or more DTX parameters relative to a bandwidth scaling factor of the first cell.

39. The wireless communications device of claim 35, wherein the at least one processor is further configured to interpret the one or more DTX parameters relative to another bandwidth scaling factor, the another bandwidth scaling factor determined by comparing at least a bandwidth scaling factor of the first cell and a bandwidth scaling factor of the second cell.

40. The wireless communications device of claim 35, wherein the at least one processor is further configured to interpret the one or more DTX parameters relative to at least a highest bandwidth scaling factor or a lowest bandwidth scaling factor or a previously chosen bandwidth scaling factor, the highest bandwidth scaling factor or the lowest bandwidth scaling factor determined by comparing at least a bandwidth scaling factor of the first cell and a bandwidth scaling factor of the second cell.

41. The wireless communications device of claim 35, wherein the first cell comprises a normal bandwidth carrier and the second cell comprises one of the one or more flexible bandwidth carriers.

42. The wireless communications device of claim 41, wherein the first cell comprises a bandwidth scaling factor equal to 1 and the second cell comprises a bandwidth scaling factor equal to 2 or 4.

43. The wireless communications device of claim 35, wherein the first cell comprises one of the one or more flexible bandwidth carriers and the second cell comprises a normal bandwidth carrier.

44. The wireless communications device of claim 43, wherein the first cell comprises a bandwidth scaling factor equal to 2 or 4 and the second cell comprises a bandwidth scaling factor equal to 1.

45. The wireless communications device of claim 35, wherein the first cell comprises one of the one or more flexible bandwidth carriers and the second cell comprises another one of the one or more flexible bandwidth carriers different from the first cell.
